(19) United States
(12) Patent Application Publication
(10) Pub. No.: US 2018/0365770 A1
(43) Pub. Date: Dec. 20, 2018

(54) DETERMINING A CATEGORIZATION VALUE BASED ON PROCESSING OF ATTRIBUTE DATA

(71) Applicant: Alibaba Group Holding Limited, George Town (KY)

(72) Inventors: Guanru Li, Hangzhou (CN); Yuxiang Lei, Hangzhou (CN); Wei Ding, Hangzhou (CN); Jing Huang, Hangzhou (CN); Chunping Tan, Hangzhou (CN); Shiyi Chen, Hangzhou (CN); Mingqian Shi, Hangzhou (CN)

(73) Assignee: Alibaba Group Holding Limited, George Town (KY)

(21) Appl. No.: 16/002,764

(22) Filed: Jun. 7, 2018

(30) Foreign Application Priority Data
Jun. 15, 2017 (CN) 201710451956.7

(51) Int. Cl. G06Q 40/08

(52) U.S. Cl. CPC G06Q 40/08

(57) ABSTRACT

A predetermined field containing attribute information associated with an auto insurance user is received at a risk assessment server and from an insurance company server. A personal attribute variable associated with the auto insurance user and a value corresponding to the personal attribute variable are obtained by querying a database based on the predetermined field. An auto insurance standard score for the auto insurance user is generated by using a predetermined calculation method with the obtained personal attribute variable and the corresponding value for the personal attribute variable. The auto insurance standard score is returned to the insurance company server.

This application claims priority to Chinese Patent Application No. 201710451956.7, filed on Jun. 15, 2017, which is hereby incorporated by reference in its entirety.

### TECHNICAL FIELD

The present application relates to the field of computer data processing technologies.

### BACKGROUND

As vehicle possession increases year by year, the insurance company's auto insurance business volume has also increased.

Currently, the insurance company's existing auto insurance business mainly relies on the vehicle's own attribute information to model the pricing, formulate the auto insurance business for different insured vehicles, and provide the service to users. For example, the annual insurance renewal premium of an insured vehicle is adjusted based on the appearance, the age of the vehicle, the mileage of the vehicle, the no claim discount (NCD), and the previous claiming record of the insured (if the insured does not claim compensation within an insurance period, the insured can get insurance premium discounts provided by the insurance company during insurance renewal), etc. The applicant finds that, in the existing technologies, other factors can also affect whether a vehicle encounters an insurance accident and a claim premium, such as a natural environment of a location of the vehicle, and a condition of a road on which the vehicle often travels. If an auto insurance risk is assessed only based on the vehicle's attribute information, the assessment will have significant limitations and the risk identification will not be sufficiently compensated. As such, auto insurance underwriting and pricing accuracy of the insurance company is reduced. In addition, different insurance companies usually formulate a plurality of different types of auto insurance businesses. Even for the same insured-vehicle information, due to differences in vehicle company background, service composition, market trends, etc., underwritten services provided by different insurance companies usually differ significantly. Therefore, the industry still lacks a reference standard that is commonly used by different insurance companies when they formulate auto insurance operation services. The reference standard is used to narrow the gap in the insurance companies' service standards when the insurance companies formulate auto insurance businesses for consumers.

With the advent of the era of big data and the constantly changing market environment, there is an urgent need for a more accurate and unified solution for accessing the auto insurance risk.

### SUMMARY

The object of the present application is to provide a data processing method, apparatus, and system for an auto insurance business. By introducing the attribute information including the driver's personal attribute information into the auto insurance risk prediction, the auto insurance risk can be assessed more accurately and more comprehensively with reference to a unified standard.

The data processing method, apparatus, and system for an auto insurance business provided in the present application are implemented by using the following methods:

A data processing method for an auto insurance business is provided, and the method includes: obtaining, by a first server, a predetermined field of an auto insurance user, and sending the predetermined field to a second server; obtaining, by the second server by means of matching, a personal attribute variable of the auto insurance user and a value corresponding to the personal attribute variable based on the predetermined field; generating, by the second server, an auto insurance standard score by using a predetermined calculation method based on the personal attribute variable and the corresponding value; returning, by the second server, the auto insurance standard score to the first server; and determining, by the first server, a service operation scheme for the auto insurance user based on the auto insurance standard score.

A data processing method for an auto insurance business is provided, and the method includes: obtaining a predetermined field of an auto insurance user, and obtaining, by means of matching, a personal attribute variable of the auto insurance user and a value corresponding to the personal attribute variable based on the predetermined field; generating an auto insurance standard score by using a predetermined calculation method based on the personal attribute variable and the corresponding value; and sending the auto insurance standard score to a first server.

A data processing method for an auto insurance business is provided, and the method includes: providing, by a second server, a risk category label, where the risk category label is generated based on classification of a personal attribute variable; sending, by a first server, obtained auto insurance user data and at least one selected risk category label to the second server; determining, by the second server, a value of a personal attribute variable in the selected risk category label based on the auto insurance user data, calculating risk data corresponding to each selected risk category label based on the value, and returning the risk data to the first server; generating, by the first server, an auto insurance dedicated score corresponding to the auto insurance user data based on the risk data; and determining, by the first server, a corresponding auto insurance business operation scheme based on the auto insurance dedicated score.

A data processing method for an auto insurance business is provided, and the method includes: providing a risk category label, where the risk category label is generated based on classification of a personal attribute variable; obtaining auto insurance user data sent by a first server and at least one selected risk category label; determining a value of a personal attribute variable in the selected risk category label based on the auto insurance user data, and calculating risk data corresponding to each selected risk category label based on the value; and returning the risk data to the first server.

A data processing method for an auto insurance business is provided, and the method includes: obtaining auto insurance user data and at least one selected risk category label, and sending the auto insurance user data and the selected risk category label to a second server; obtaining risk data, calculated by the second server, of the selected risk category label, and generating an auto insurance dedicated score corresponding to the auto insurance user data based on the risk data; and determining a corresponding auto insurance business operation scheme based on the auto insurance dedicated score.

A data processing method for an auto insurance business is provided and includes: providing, by a second server, a risk category label, where the risk category label is generated based on classification of a personal attribute variable; sending, by a first server, obtained auto insurance user data and at least one selected risk category label to the second server; determining, by the second server, a value of a personal attribute variable in the selected risk category label based on the auto insurance user data, and calculating risk data corresponding to each selected risk category label based on the value; and generating, by the second server, an auto insurance dedicated score corresponding to the auto insurance user data based on the risk data.

A data processing method for an auto insurance business is provided and includes: providing a risk category label, where the risk category label is generated based on classification of a personal attribute variable; obtaining auto insurance user data sent by a first server and at least one selected risk category label; determining a value of a personal attribute variable in the selected risk category label based on the auto insurance user data, and calculating risk data corresponding to each selected risk category label based on the value; and generating an auto insurance dedicated score corresponding to the auto insurance user data based on the risk data.

A data processing method for an auto insurance business is provided and includes: obtaining auto insurance user data and at least one selected risk category label, and sending the auto insurance user data and the selected risk category label to a second server; obtaining an auto insurance dedicated score calculated by the second server, where the auto insurance dedicated score includes an auto insurance dedicated score that is generated by the second server, and the second server determines risk data corresponding to the selected risk category label based on the auto insurance user data; and determining a corresponding auto insurance business operation scheme based on the auto insurance dedicated score.

A data processing apparatus for an auto insurance business is provided, and the apparatus includes: a field matching module, configured to obtain a predetermined field of an auto insurance user, and obtain, by means of matching, a personal attribute variable of the auto insurance user and a value corresponding to the personal attribute variable based on the predetermined field; a standard score calculation module, configured to generate an auto insurance standard score by using a predetermined calculation method based on the personal attribute variable and the corresponding value; and a communication module, configured to send the auto insurance standard score to a first server.

A data processing apparatus for an auto insurance business is provided, and the apparatus includes: a label module, configured to provide a risk category label, where the risk category label is generated based on classification of a personal attribute variable; an information obtaining module, configured to obtain auto insurance user data sent by a first server and at least one selected risk category label; a label risk calculation module, configured to determine a value of a personal attribute variable in the selected risk category label based on the auto insurance user data, and calculate risk data corresponding to each selected risk category label based on the value; and a communication module, configured to return the risk data to the first server.

A data processing apparatus for an auto insurance business is provided, and the apparatus includes: an auto insurance data processing module, configured to obtain auto insurance user data and at least one selected risk category label, and send the auto insurance user data and the selected risk category label to a second server; a label risk calling module, configured to obtain risk data, calculated by the second server, of the selected risk category label, and generate an auto insurance dedicated score corresponding to the auto insurance user data based on the risk data; and an auto insurance business processing module, configured to determine a corresponding auto insurance business operation scheme based on the auto insurance dedicated score.

A data processing apparatus for an auto insurance business is provided, and the apparatus includes: a label module, configured to provide a risk category label, where the risk category label is generated based on classification of a personal attribute variable; an information obtaining module, configured to obtain auto insurance user data sent by a first server and at least one selected risk category label; a label risk calculation module, configured to determine a value of a personal attribute variable in the selected risk category label based on the auto insurance user data, and calculate risk data corresponding to each selected risk category label based on the value; and a dedicated score calculation module, configured to generate an auto insurance dedicated score corresponding to the auto insurance user data based on the risk data.

A data processing apparatus for an auto insurance business is provided, and the apparatus includes: an auto insurance data processing module, configured to obtain auto insurance user data and at least one selected risk category label, and send the auto insurance user data and the selected risk category label to a second server; a dedicated score calling module, configured to obtain an auto insurance dedicated score calculated by the second server, where the auto insurance dedicated score includes an auto insurance dedicated score that is generated by the second server, and the second server determines risk data corresponding to the selected risk category label based on the auto insurance user data; and an auto insurance business processing module, configured to determine a corresponding auto insurance business operation scheme based on the auto insurance dedicated score.

A data processing apparatus for an auto insurance business is provided and includes a processor and a memory that is configured to store a processor-executable instruction, and when executing the instruction, the processor implements the following operations: obtaining a predetermined field of an auto insurance user, and obtaining, by means of matching, a personal attribute variable of the auto insurance user and a value corresponding to the personal attribute variable based on the predetermined field; generating an auto insurance standard score by using a predetermined calculation method based on the personal attribute variable and the corresponding value; and sending the auto insurance standard score to a first server.

A data processing apparatus for an auto insurance business is provided and includes a processor and a memory that is configured to store a processor-executable instruction, and when executing the instruction, the processor implements the following operations: providing a risk category label, where the risk category label is generated based on classification of a personal attribute variable; obtaining auto insurance user data sent by a first server and at least one selected risk category label; determining a value of a personal attribute variable in the selected risk category label based on the auto insurance user data, and calculating risk data corresponding to each selected risk category label based on the value; and returning the risk data to the first server.

A data processing apparatus for an auto insurance business is provided and includes a processor and a memory that is configured to store a processor-executable instruction, and when executing the instruction, the processor implements the following operations: obtaining auto insurance user data and at least one selected risk category label, and sending the auto insurance user data and the selected risk category label to a second server; obtaining risk data, calculated by the second server, of the selected risk category label, and generating an auto insurance dedicated score corresponding to the auto insurance user data based on the risk data; and determining a corresponding auto insurance business operation scheme based on the auto insurance dedicated score.

A data processing apparatus for an auto insurance business is provided and includes a processor and a memory that is configured to store a processor-executable instruction, and when executing the instruction, the processor implements the following operations; providing a risk category label, where the risk category label is generated based on classification of a personal attribute variable; obtaining auto insurance user data sent by a first server and at least one selected risk category label; determining a value of a personal attribute variable in the selected risk category label based on the auto insurance user data, and calculating risk data corresponding to each selected risk category label based on the value; and generating an auto insurance dedicated score corresponding to the auto insurance user data based on the risk data.

A data processing apparatus for an auto insurance business is provided and includes a processor and a memory that is configured to store a processor-executable instruction, and when executing the instruction, the processor implements the following operations: obtaining auto insurance user data and at least one selected risk category label, and sending the auto insurance user data and the selected risk category label to a second server; obtaining an auto insurance dedicated score calculated by the second server, where the auto insurance dedicated score includes an auto insurance dedicated score that is generated by the second server, and the second server determines risk data corresponding to the selected risk category label based on the auto insurance user data; and determining a corresponding auto insurance business operation scheme based on the auto insurance dedicated score.

An auto insurance risk assessment system is provided and includes a processor and a memory that is configured to store a processor-executable instruction, and when executing the instruction, the processor implements the steps of the method in any item of the present application; or the system includes the apparatus in any item of the present application.

The present application provides a data processing method, apparatus, and system for an auto insurance business, and some attribute information related to a person, such as a physical feature (such as an age, gender, etc.), a credit history, and a driving habit are used, so that a unified standard score can be output after quantization. An insurance company can use the standard score to model and apply it to an auto insurance underwriting and pricing process, making an output auto insurance business operation scheme more accurate. For the same data processing object such as attribute information of a same person, the auto insurance standard score provided in the present application can be uniformly output to various insurance companies, providing the industry with a reference standard that is commonly used by different insurance companies when they formulate auto insurance operation services, narrowing the gap in the insurance companies' service standards when they formulate auto insurance businesses for consumers, and promoting the fair and healthy development in the industry.

### BRIEF DESCRIPTION OF DRAWINGS

To describe the technical solutions in the embodiments of the present application or in the existing technology more clearly, the following briefly introduces the accompanying drawings required for describing the embodiments or the existing technology. Apparently, the accompanying drawings in the following description merely show some embodiments described in the present application, and a person of ordinary skill in the art can still derive other drawings from these accompanying drawings without creative efforts.

FIG. 1 is a schematic flowchart illustrating an embodiment of a data processing method for an auto insurance business, according to the present application.

FIG. 2 is a schematic diagram illustrating an implementation scenario of a data processing method for an auto insurance business, according to the present application.

FIG. 3 is a schematic diagram illustrating an implementation scenario of another data processing method for an auto insurance business, according to the present application.

FIG. 4 is a schematic flowchart illustrating a data processing method for an auto insurance business that can be used for a second server, according to the present application.

FIG. 5 is a schematic method flowchart illustrating an embodiment of another data processing method for an auto insurance business, according to the present application.

FIG. 6 is a schematic method flowchart illustrating an embodiment of another data processing method for an auto insurance business, according to the present application.

FIG. 7 is a schematic flowchart illustrating another data processing method for an auto insurance business that can be used for a second server, according to the present application.

FIG. 8 is a schematic flowchart illustrating a data processing method for an auto insurance business that can be used for a second server, according to the present application.

FIG. 9 is a schematic method flowchart illustrating another embodiment of a data processing method for an auto insurance business, according to the present application.

FIG. 10 is a schematic flowchart illustrating another data processing method for an auto insurance business that can be used for a second server, according to the present application.

FIG. 11 is a schematic flowchart illustrating another data processing method for an auto insurance business that can be used for a second server, according to the present application.

FIG. 12 is a schematic flowchart illustrating another data processing method for an auto insurance business that can be used for a first server, according to the present application.

FIG. 13 is a schematic module structure diagram illustrating an embodiment of a data processing apparatus for an auto insurance business, according to the present application.

FIG. 14 is a schematic module structure diagram illustrating an embodiment of a communication module in the apparatus, according to the present application.

FIG. 15 is a schematic module structure diagram illustrating an embodiment of another data processing apparatus for an auto insurance business, according to the present application.

FIG. 16 is a schematic module structure diagram illustrating an embodiment of a data processing apparatus for an auto insurance business, according to the present application.

FIG. 17 is a schematic module structure diagram illustrating an embodiment of a data processing apparatus for an auto insurance business, according to the present application.

FIG. 18 is a schematic module structure diagram illustrating an embodiment of a data processing apparatus for an auto insurance business, according to the present application.

FIG. 19 is a schematic module structure diagram illustrating an embodiment of a data processing apparatus for an auto insurance business, according to the present application.

FIG. 20 is a schematic structural diagram illustrating that a data processing apparatus for an auto insurance business is applied to a server, according to the present application.

FIG. 21 is a schematic structural diagram illustrating that another data processing apparatus for an auto insurance business is applied to a server, according to the present application.

FIG. 22 is a flowchart illustrating an example of a computer-implemented method for computer data processing, according to an implementation of the present disclosure.

### DESCRIPTION OF EMBODIMENTS

To make a person skilled in the art better understand the solutions in the present application, the following description clearly and comprehensively describes the technical solutions in the embodiments of the present application with reference to the accompanying drawings. Apparently, the described embodiments are merely some rather than all of the embodiments of the present application. All other embodiments obtained by a person of ordinary skill in the art based on the embodiments of the present application without creative efforts shall fall within the protection scope of the present application.

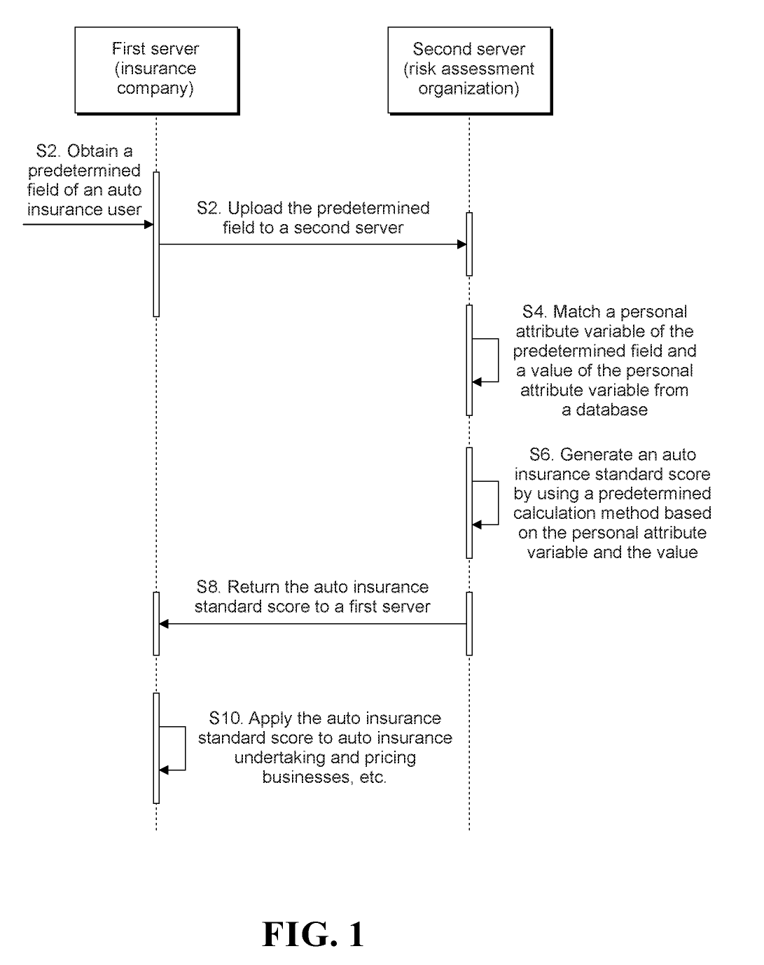

FIG. 1 is a schematic flowchart illustrating an embodiment of a data processing method for an auto insurance business, according to the present application. Although the present application provides method operation steps or an apparatus structure shown in the following embodiment or the accompanying drawings, the method or apparatus can include, based on conventional or non-creative effort, more operation steps or module units, or fewer operation steps or module units after combination of some operation steps or module units. In steps or structures without necessary logical causality, the execution sequence of these steps or the module structure of the apparatus is not limited to the execution sequence or the module structure shown in the embodiment of the present application or the accompanying drawings. When used in an actual apparatus, server, or terminal product, the method or module structure can be executed in a sequence based on the method or module structure shown in the embodiment or the accompanying drawings or can be executed in parallel (for example, an environment of parallel processors or multi-thread processors, or even an implementation environment of distributed processing and server clustering).

As an example, the following describes an implementation solution of the present application in detail by using a specific implementation scenario. In this scenario, an insurance company assesses an auto insurance risk of a vehicle owner to formulate an underwritten and priced service. In this implementation scenario, an insurance company can be used as a first server, and a party that cooperates with the insurance company to formulate and generate an auto insurance standard score is referred to as a second server. The first server can provide data information of a vehicle owner who needs to be assessed. For example, information about one or more fields required for determining a vehicle standard score such as policy data or basic identity characteristic data. The second server can include a service organization that provides an auto insurance standard score (the service organization can provide an auto insurance dedicated score or a risk category label in another embodiment) for the first server. For example, a processing server in a third-party risk assessment system can match some attribute information of the vehicle owner from a database based on the field information provided by the first server. The attribute information can exist in a form of data of one or more attribute variables. The second server can calculate the auto insurance standard score of the vehicle owner based on the attribute information associated with a person, and then can return the auto insurance standard score to the insurance company for the formulation, guidance, and reference of various service operation solutions. Specifically, as shown in FIG. 1, in an embodiment of the data processing method for a vehicle service provided in the present application, the method can include the following steps:

S2. The first server obtains a predetermined field of an auto insurance user, and sends the predetermined field to the second server.

Generally, the first server on the side of the insurance company can record some information data of the auto insurance user, such as filled-in policy data. Such data can specifically include a name of a vehicle owner, an identification type, an identification number, a mobile phone number, etc. After obtaining authorization from the auto insurance user, the first server can send one or more of the information data to the second server. In this embodiment, predetermined fields that need to be uploaded to the second server for determining the auto insurance standard score can be set in advance. In this way, the first server can obtain, from the recorded information data, the predetermined field required for scoring, and then directly send the predetermined field to the second server.

In a specific example, if an insurance company A records policy data L1 of a vehicle owner U1, the policy data includes information such as a name, an identity card number, a mobile phone number, an occupation, and an annual income of the vehicle owner U1. If the predetermined field is set as the owner's name, identification type, and identification number, then in the case of having authorization of the vehicle owner U1, three predetermined fields, which are, the name of the vehicle owner is “U1”, the identification type is “identity card”, and the identification number is “320322XXXXXXXXXXXXX”, can be sent to the second server. Certainly, it is also possible to send only the predetermined field of the identification number.

It should be noted that the auto insurance user in this embodiment generally refers to an actual owner to which an insured vehicle registers to, such as a vehicle owner. The auto insurance user in the present application can include, in a broader sense, the vehicle owner U1 in the embodiment mentioned above or an auto insurance business applicant, or can include other insured/beneficiaries in auto insurance business, such as an immediate family member U11 of the vehicle owner U1. Or when the vehicle owner is a legal person, an auto insurance user can be a legal representative (natural person), etc. In some cases, an auto insurance user can even include a passenger of the vehicle. The auto insurance user in the present application is not limited to a vehicle owner user of an auto insurance business. To more fully consider an interested party involved in the auto insurance business, the user described above can be further included in some embodiments.

In this embodiment, the first server on the side of the insurance company can obtain a predetermined field of an auto insurance user in the auto insurance business, and then can send one or more predetermined fields required for determining an auto insurance standard score to the second server.

S4. The second server obtains, by means of matching, a personal attribute variable of the auto insurance user and a value corresponding to the personal attribute variable based on the predetermined field.

The second server obtains the predetermined field uploaded by the first server, and can perform query in a database based on the predetermined field, to obtain one or more personal attribute variables of the auto insurance user and a value corresponding to the personal attribute variable. The personal attribute variable in this embodiment can include a variable field that is set based on attribute information of a person, and the attribute information can specifically include a plurality of types of data information such as self-physique information, social relationship information, personality information, social value information, driving behavior, etc. The second server can pre-collect or record attribute information of the auto insurance user, and then set several personal attribute variables based on the needs of the auto insurance business, including different types of variables such as an occupation, a consumption habit, and a credit history. Each type can include one or more variables. For example, in the attribute information of credit history, a personal attribute variable including a first credit Tru_Card, a second credit Tru_Life, and a third credit Tru_Bank, can be set.

The second server can store the personal attribute variable and the corresponding value in a database of the second server. It can also store the attribute information of the auto insurance user, and then convert the attribute information into a personal attribute variable and a corresponding value after performing corresponding calculation. In an implementation scenario, the second server can use attribute information in the database of the second server, or can partially or entirely use data of attribute information on another server or storage apparatus. The second server can perform matching in the database of the attribute information based on the predetermined field uploaded by the first server, to obtain one or more personal attribute variables of the auto insurance user U1 and a corresponding value. For example, a relevant feature of this vehicle owner can be matched in the database based on a predetermined field of an identification number, such as a credit score, social relationship activeness, etc. of the vehicle owner.

Generally, the second server can be set to match a plurality of personal attribute variables based on the predetermined field to assess an auto insurance risk of the auto insurance user from a plurality of attribute dimensions. Specifically, based on a design requirement of the auto insurance standard score, it is possible to set which personal attribute variables need to be matched.

Certainly, if the second server fails to match a certain personal attribute variable or some personal attribute variables of the auto insurance user, for example, data information of a certain personal attribute variable of the auto insurance user fails to be collected from the database, or the auto insurance user has not authorized/enabled the second server to record a personal attribute variable, the personal attribute variable can be set to null or 0 or a default value, or can be processed by using another predetermined method.

S6. The second server generates an auto insurance standard score by using a predetermined calculation method based on the personal attribute variable and the corresponding value.

The second server can pre-formulate a uniform calculation method, and calculate the relevant characteristic data of the matched auto insurance user to generate the auto insurance standard score of the auto insurance user. The specific predetermined calculation method of the personal attribute variable and the value corresponding to such variable can be based on the applicant environment of the auto insurance business, to formulate a uniform calculation standard, which is applicable to each insurance company. The predetermined calculation method can include not only how to perform mathematical calculation among individual personal attribute variables, but can also include how to select personal attribute variables or a processing method/process of transforming, converting, or weighting the personal attribute variable.

In a specific example, the second server uses 13 personal attribute variables, including data of 6 identity characteristic types of an auto insurance user, characteristic data of 4 driving habit types, data of 2 credit types, and data of 1 occupational characteristic. The predetermined calculation method is used to add up values of the 13 personal attribute variables, and the obtained sum value is used as the auto insurance standard score of the auto insurance user. Certainly, as previously described, if no personal attribute variable of the auto insurance user is recorded in the database, for example, if the second credit information of the data of 2 credit types of the auto insurance user is not recorded, the personal attribute variable can be set to 0 or a default value.

In some other implementation scenarios, the value of the personal attribute variable can be further preprocessed, so that the calculated auto insurance standard score is more intuitive and simple to show the level of risk. For example, if a score of a personal attribute variable of a certain credit of the auto insurance user U1 is 700, a personal attribute variable of the age of the auto insurance user U1 is 24, and in some application scenarios, the age and the credit are considered as equally important, then a data conversion method that is similar to normalization can be used. The data conversion method can convert values of all or some personal attribute variables into the same order of magnitude. In this way, the final auto insurance standard score calculation result can more closely match the personal attribute variable, and it is also easier to be understood by the insurance company and the public.

Certainly, during calculation of the auto insurance standard score, the second server can further set different weights based on the importance of the personal attribute variables in auto insurance assessment. For example, if a driving habit type has relatively great impact on a risk of the auto insurance business, the weight of the personal attribute variable of the driving habit type can be set to be larger than other types. For example, the value of the personal attribute variable is multiplied by a weight coefficient 1.5. The specific weight of a corresponding variable can be set based on an auto insurance risk assessment requirement.

In an embodiment of the present application, the predetermined calculation method of the auto insurance standard score can be set to be globally unique, that is, the second server uses a uniform and stable auto insurance standard score calculation method. In this way, for the same auto insurance user, different auto insurance companies return a consistent auto insurance standard score by means of calling and through the second server. Therefore, in an embodiment of the method provided in the present application, S601: the predetermined calculation method is set to be globally unique.

Specifically, the global here can mean that for different insurance companies, the calculation method of the auto insurance standard score provided by the second server is unified. For example, for a certain vehicle owner, when different insurance companies call for their auto insurance standard scores, the obtained scores are consistent. In this way, it can ensure that a unified and stable auto insurance basic score is provided for a plurality of insurance companies in the industry, allowing different insurance companies to share the same calculation standard for their auto insurance basic scores. As such, healthy competition in the auto insurance industry is promoted, and more fair and reasonable auto insurance products can be provided for consumers.

It should be noted that the predetermined calculation method can be properly optimized and adjusted based on a design or service requirement. For example, after operation for a period of time, based on feedback from each insurance company, it is possible to add another personal attribute variable that is considered by another insurance company to have relatively great impact on auto insurance risk assessment, making the auto insurance standard score more accurate.

S8. The second server returns the auto insurance standard score to the first server.

After calculating the auto insurance standard score of the auto insurance user, the second server can transmit the auto insurance standard score to the first server by using an agreed communication method, so that the first server uses the auto insurance standard score to process a corresponding auto insurance business. In a specific implementation, the second server can store an auto insurance standard score calculation result of each auto insurance user locally or in a designated database/table, and can provide a calling interface of a cooperative insurance company. In this way, the first server can call an auto insurance standard score calculation result of the second server by using a pre-agreed interface.

Certainly, in another implementation, the second server can also actively send the auto insurance standard score to the first server. For example, after calculating the auto insurance standard score of the auto insurance user, the second server directly sends the auto insurance standard score to the first server.

S10. The first server determines a service operation scheme for the auto insurance user based on the auto insurance standard score.

The first server can use the auto insurance standard score returned by the second server as a basis for formulating the service operation scheme for the auto insurance user, and can finally determine the service operation scheme for the auto insurance user. For example, an insurance company can apply the obtained auto insurance standard score to the process of underwriting and pricing for auto insurance users. For example, if the auto insurance standard score is relatively high, it indicates that an auto insurance risk of the user is relatively small, and the user can get a discount based on the range the auto insurance standard score is in. It can be set that the higher the auto insurance standard score is, the greater the discount is.

During determining of the service operation scheme for the auto insurance user based on the auto insurance standard score, different service operation schemes can be set based on respective auto insurance formulating policies of insurance companies. For example, in an implementation scenario, the service operation scheme can include: if the auto insurance standard score is lower than a minimum score of 300 that is set by an insurance company, the insurance company can refuse to underwrite the auto insurance user, or give him no discount, or add some risk fees to the standard premium base. Therefore, the service operation solution described in this embodiment can include a specific undertaking or pricing auto insurance business that is formulated for the auto insurance user, or can include an operation policy executed for the auto insurance user For example, refusing to underwrite the aforementioned user whose auto insurance basic score is lower than 300 scores.

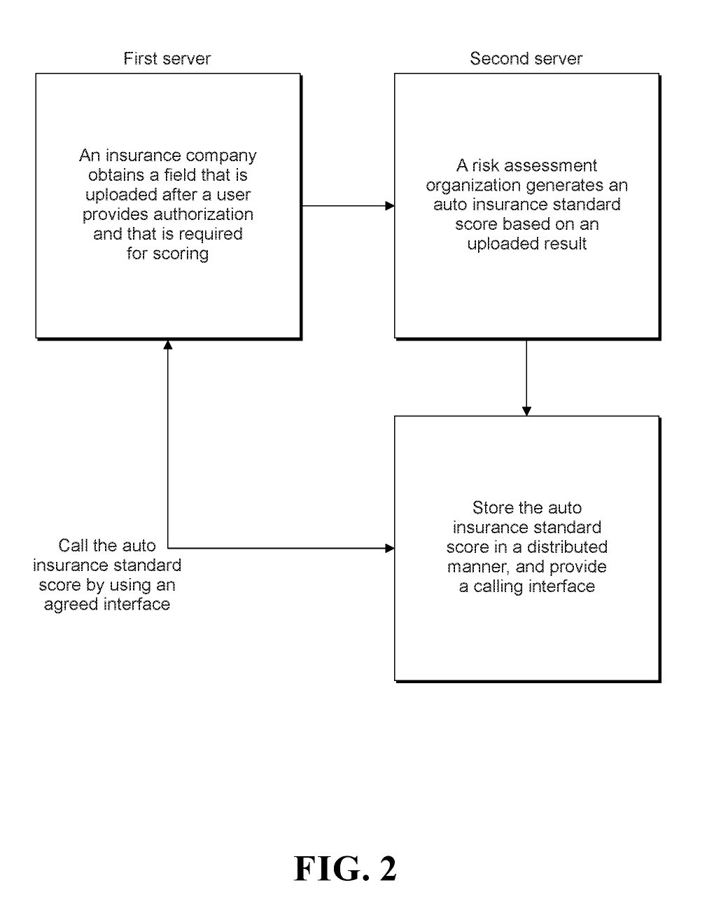

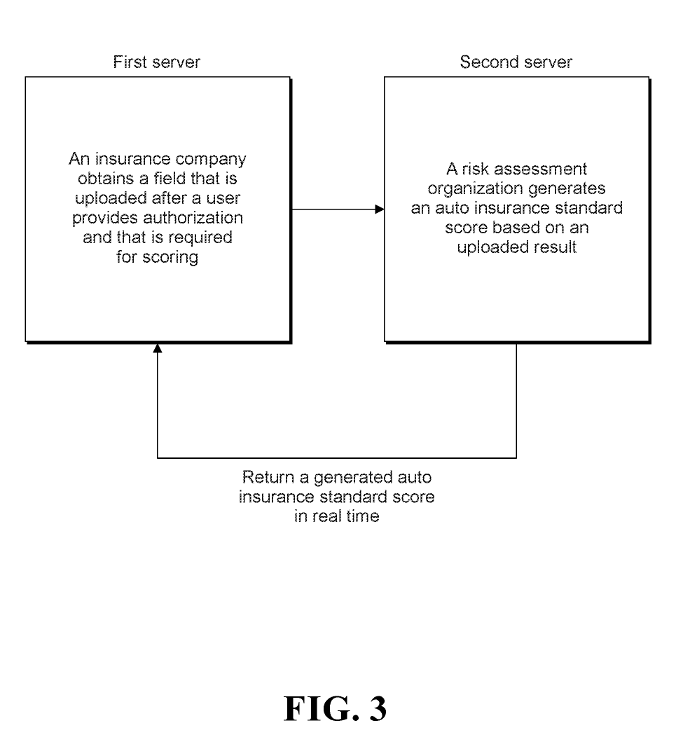

FIG. 2 and FIG. 3 are separately schematic diagrams illustrating an implementation scenario of the data processing method for an auto insurance business, according to the present application. As shown in FIG. 2 and FIG. 3, the second server returns the auto insurance standard score to the first server by using at least one of the following methods: storing the auto insurance standard score in a specified position, and providing an interface that is used by the first server to call the auto insurance standard score, and correspondingly, obtaining, by the first server, the auto insurance standard score by calling the interface; or sending the auto insurance standard score to the first server in real time.

The second server (an auto insurance standard score service organization) can provide two auto insurance standard score processing methods, that is, offline scoring and online scoring. Specific implementation of offline scoring can include: the insurance company uploads policy data of the auto insurance user in advance, and the second server performs calculation and scoring in advance, to obtain the auto insurance standard score of the auto insurance user. Then, a scoring result can be stored in a designated database table (such as a distributed database), and deployed online. In this way, the insurance company can call the auto insurance standard score of the auto insurance user by using a pre-determined interface. Offline scoring can be understood as a processing method of transmitting the scoring result to the first server in one step. In another implementation of online real-time scoring, the specific implementation can include: deploying the scoring logic of the auto insurance standard score and putting the scoring logic online. The first server can input a predetermined field required for scoring, and can obtain, in real time, the auto insurance standard score calculated by the second server.

In the data processing method for an auto insurance business provided in the present application, some attribute information of a person, such as an identity characteristic, a credit history, a driving habit, and income stability are used, so that a unified standard score can be output after quantization. An insurance company can use the standard score to model and apply it to an auto insurance underwriting and pricing process, making an output auto insurance business operation scheme more accurate. For the same data processing object such as attribute information of a same person, the auto insurance standard score provided in the present application can be uniformly output to various insurance companies, providing the industry with a reference standard that is commonly used by different insurance companies when they formulate auto insurance operation services, narrowing the gap in the insurance companies' service standards when they formulate auto insurance businesses for consumers, and promoting the fair and healthy development in the industry.

The embodiment mentioned above describes an implementation solution of the data processing method for an auto insurance business according to the present application from an interaction side of the insurance company (the first server) and a service organization (the second server) that provides an auto insurance standard score output result. Based on the descriptions mentioned above, the present application further provides a data processing method for an auto insurance business that can be used for an auto insurance standard score service organization, that is, for a side of a second server that provides an auto insurance standard score, the method can include the following steps:

S22. Obtain a predetermined field of an auto insurance user, and obtain, by means of matching, a personal attribute variable of the auto insurance user and a value corresponding to the personal attribute variable based on the predetermined field.

S24. Generate an auto insurance standard score by using a predetermined calculation method based on the personal attribute variable and the corresponding value.

S26. Send the auto insurance standard score to a first server.

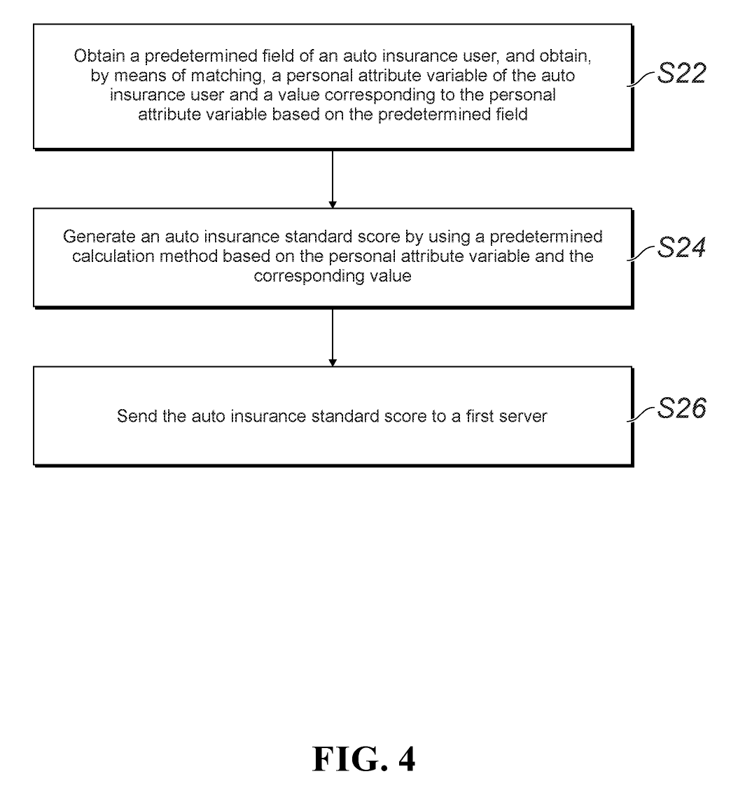

FIG. 4 is a schematic flowchart illustrating a data processing method for an auto insurance business that can be used for a second server, according to the present application.

In other implementations, the predetermined calculation method can be set to be globally unique. The second server returns the auto insurance standard score to the first server by using at least one of the following methods: storing the auto insurance standard score in a specified position, and providing an interface that is used by the first server to call the auto insurance standard score, and correspondingly, obtaining, by the first server, the auto insurance standard score by calling the interface; or sending the generated auto insurance standard score to the first server in real time.

For a specific implementation, reference can be made to previous descriptions of the embodiment of an interaction side of the first server and the second server, which is not described herein again.

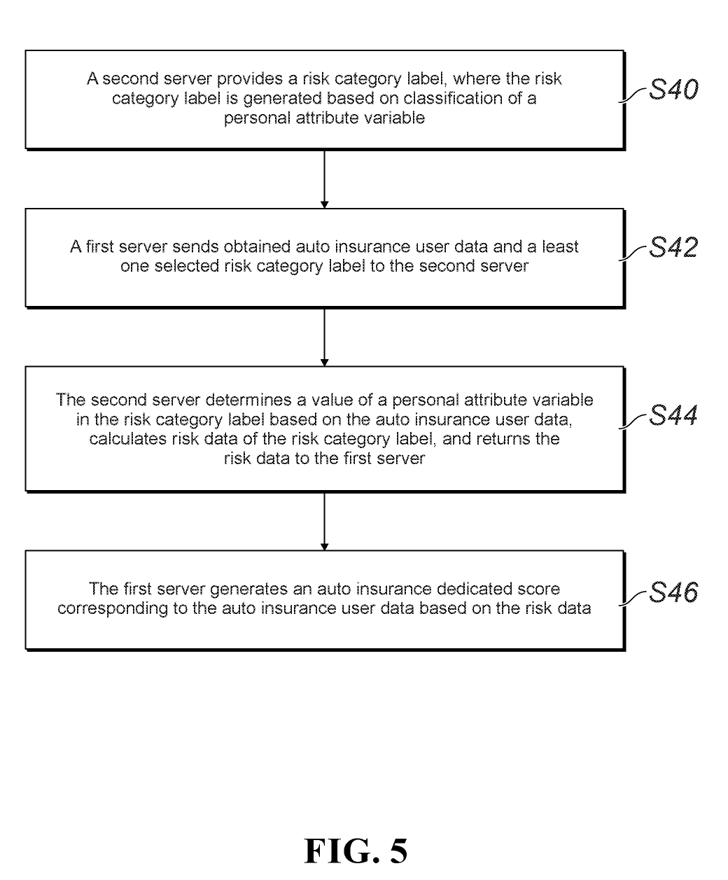

Based on one of the innovative ideas of the present application, that is, the use of the attribute information associated with the person to carry out the assessment of the auto insurance risk, it in turn makes underwriting and pricing in an auto insurance business more accurate and reasonable. The present application further provides an embodiment of another data processing method for an auto insurance business. In this embodiment of the present application, personal attribute variables stored in or obtained by the second server can be integrated and classified, to generate a plurality of types of risk labels. These risk labels can be provided for an insurance company for selection. Each insurance company can select a required type of risk label based on its auto insurance business operation policy. Then the second server or the first server can generate auto insurance dedicated scores for different insurance companies or more specifically for different auto insurance businesses. FIG. 5 is a schematic method flowchart illustrating an embodiment of another data processing method for an auto insurance business, according to the present application. As shown in FIG. 5, the method can include the following steps:

S40. A second server provides a risk category label, where the risk category label is generated based on classification of a personal attribute variable.

S42. A first server sends obtained auto insurance user data and at least one selected risk category label to the second server.

S44. The second server determines a value of a personal attribute variable in the selected risk category label based on the auto insurance user data, calculates risk data corresponding to each selected risk category label based on the value, and returns the risk data to the first server.

S46. The first server generates an auto insurance dedicated score corresponding to the auto insurance user data based on the risk data.

In this embodiment, the second server can aggregate and integrate a plurality of types of risk labels. Then, an insurance company can use auto insurance user data that it needs to process, and select one or more of the labels with reference to its own experience or a service requirement. The second server returns actual risk data of the selected one or more labels, and the first server can use one or more pieces of the returned risk data of these types, to generate an auto insurance dedicated score of the first server.

In a specific example, the auto insurance user data input by the first server is policy data of a vehicle owner, and the risk category label selected by the insurance company is a driving habit, an identity characteristic, a credit history, and a consumption level. The second server can check the values of the individual attribute variables under the four risk category labels respectively selected in the database according to the vehicle owner policy data. For example, a risk category label of the credit history includes three attribute variables: a first credit Tru_Card, a second credit Tru_Life, and a third credit Tru_Bank, through the query or the conversion of a corresponding value (for example, credit “good” can be converted to a value of 80 points, out of 100 points), to get values of personal attribute variables of the credits are respectively excellent, medium, and good. In this case, the second server can further obtain, based on these values and by using a certain method, the risk data of the risk category label of the credit history is good. The risk data can be a specific value, for example, risk data of the consumption level is 8000. It can also be a character string that reflects a risk level, such as good, excellent, healthy, etc. The first server can convert these character strings into corresponding values used for calculating the auto insurance dedicated score. For example, if the risk data of the credit history is good, the character string can be converted to a value 80. The first server can perform calculation on risk data of each selected risk category labels by using a specific method, for example, it adds up corresponding scores, to generate the auto insurance dedicated score.

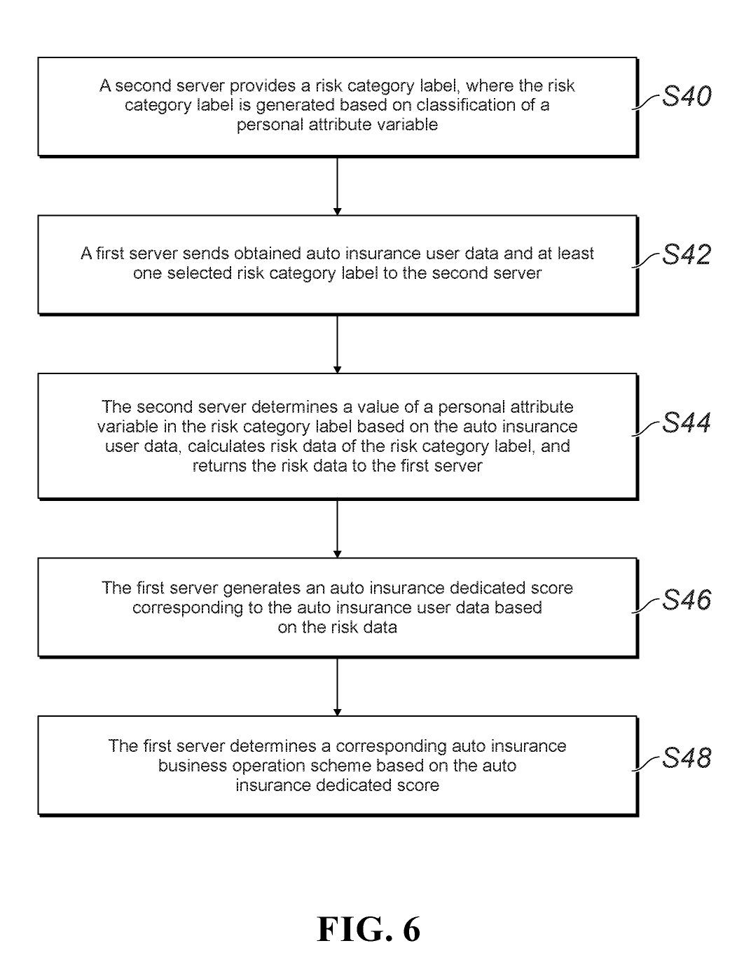

Further, as shown in FIG. 6, the method can further include: S48. The first server determines a corresponding auto insurance business operation scheme based on the auto insurance dedicated score.

FIG. 6 is a schematic method flowchart illustrating an embodiment of another data processing method for an auto insurance business, according to the present application. In this way, based on an implementation solution of the present application, auto insurance dedicated scores that are applicable to different differentiation of insurance companies and meet assessment requirements of the insurance companies can be generated. Such a score can be generated based on assessment preferences of the insurance companies for different auto insurance risk types to improve flexibility and expansibility of auto insurance risk assessment, and to meet auto insurance risk assessment requirements of the insurance companies. Then, the auto insurance dedicated score can be used in an auto insurance business such as underwriting and pricing.

The auto insurance user data can include data that is sent by the insurance company to the second server for auto insurance risk assessment, and can include the predetermined field, the policy data, or other types of data information of the auto insurance user described in the embodiments mentioned above. As described previously, the personal attribute variable in the embodiment mentioned above can include a variable field that is set based on the personal attribute information, and the attribute information can specifically include a plurality of types of data information such as self-physique information, social relationship information, personality information, social value information, etc. In an embodiment provided in the method in the present application, the risk category label provided by the second server can include at least one of the following types: a driving habit, an occupational characteristic, an identity characteristic, a credit history, a consumption habit, and stability.

Certainly, another type of risk category label can also be formulated. The risk category label of the previous type provided in this embodiment includes various types of risk factors that may be used in conventional auto insurance risk assessment, and can well meet an auto insurance risk assessment requirement of an insurance company. In the follow-up, the risk category label can be added or modified based on the requirement.

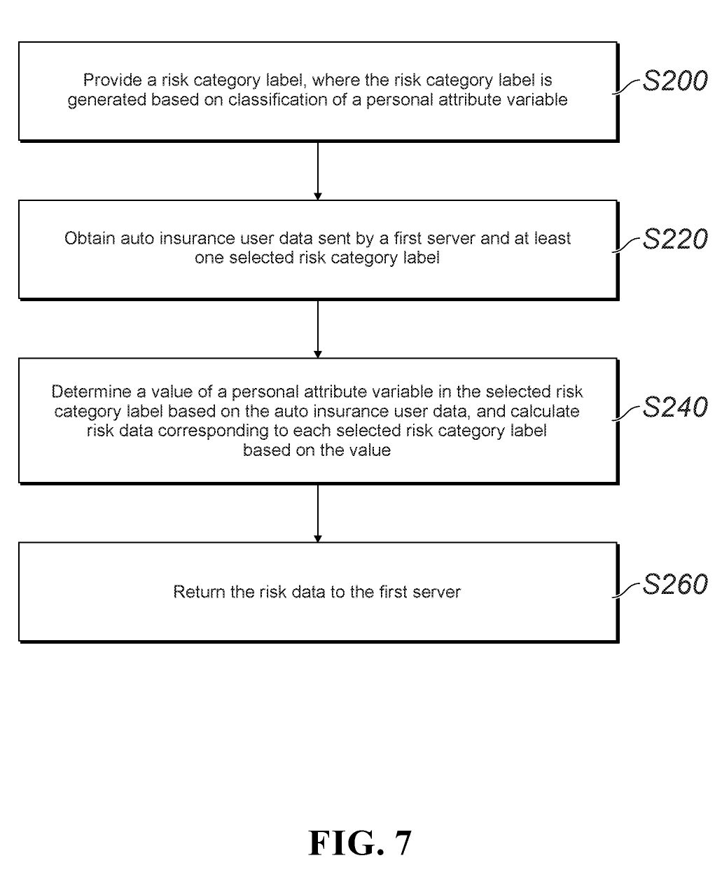

Similarly, based on descriptions of the embodiment of the above-mentioned first-server and second-server auto insurance business data exchange processing on both sides, the present application further provides a data processing method for an auto insurance business that can be used for the second server (for example, an organization that provides an auto insurance dedicated score service). FIG. 7 is a schematic flowchart illustrating another data processing method for an auto insurance business that can be used for a second server, according to the present application. As shown in FIG. 7, the method can include the following steps:

S200. Provide a risk category label, where the risk category label is generated based on classification of a personal attribute variable.

S220. Obtain auto insurance user data sent by a first server and at least one selected risk category label.

S240. Determine a value of a personal attribute variable in the selected risk category label based on the auto insurance user data, and calculate risk data corresponding to each selected risk category label based on the value.

S260. Return the risk data to the first server.

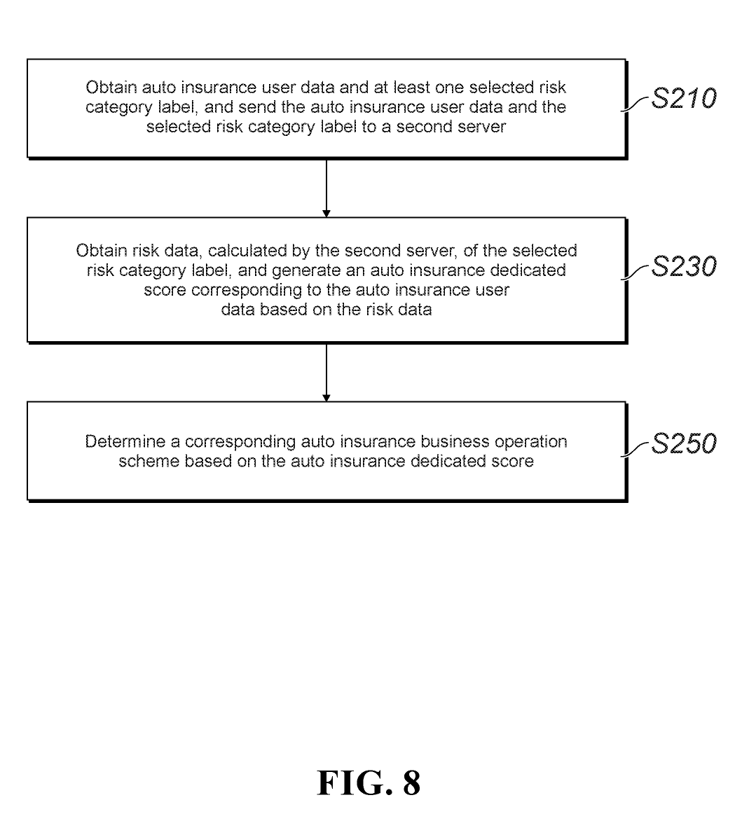

Similarly, based on descriptions of the embodiment of auto insurance business data exchange processing between the first server and the second server, the present application further provides a data processing method for an auto insurance business that can be used for the first server (for example, a server on the side of an insurance company). FIG. 8 is a schematic flowchart illustrating another data processing method for an auto insurance business that can be used for a first server, according to the present application. As shown in FIG. 8, the method can include the following steps:

S210. Obtain auto insurance user data and at least one selected risk category label, and send the auto insurance user data and the selected risk category label to a second server.

S230. Obtain risk data, calculated by the second server, of the selected risk category label, and generate an auto insurance dedicated score corresponding to the auto insurance user data based on the risk data.

S250. Determine a corresponding auto insurance business operation scheme based on the auto insurance dedicated score.

For the auto insurance business operation scheme, reference can be made to an implementation of the previous service operation solution for the auto insurance user, which is not described herein again.

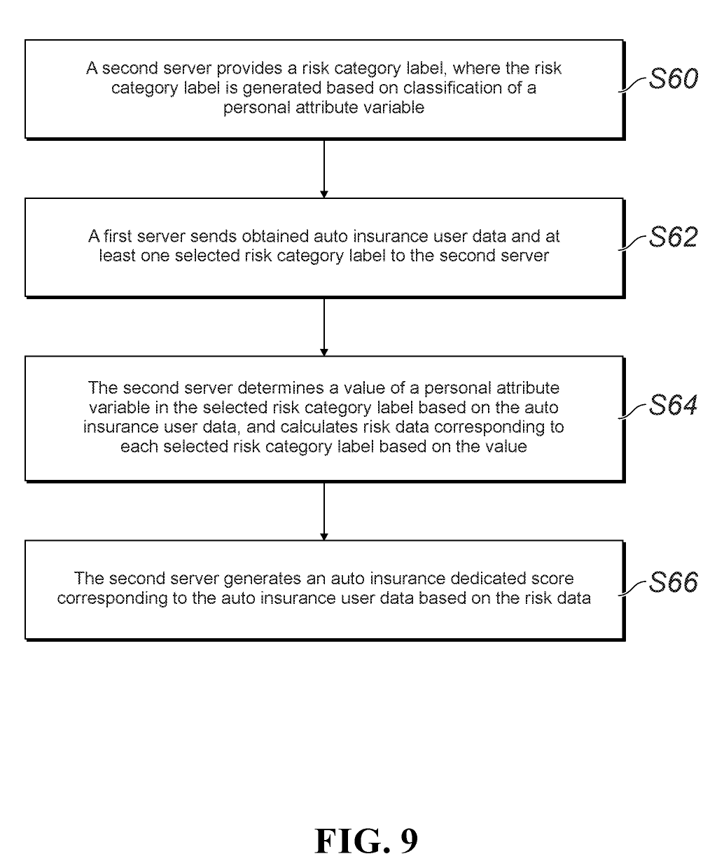

The embodiment mentioned above provides an implementation that the first server selects one or more risk category labels, the second server outputs risk data of the risk category labels, and then the first server uses its all or part of risk data, based on a requirement, to generate an auto insurance dedicated score. The present application further provides another implementation. After the first server inputs auto insurance user data and selects a risk category label, the second server directly matches, calculates, and generates an auto insurance dedicated score, and then returns the auto insurance dedicated score to the first server. FIG. 9 is a schematic method flowchart of another embodiment of the method, according to the present application. As shown in FIG. 9, the method can include the following steps:

S60. A second server provides a risk category label, where the risk category label is generated based on classification of a personal attribute variable.

S62. A first server sends obtained auto insurance user data and at least one selected risk category label to the second server.

S64. The second server determines a value of a personal attribute variable in the selected risk category label based on the auto insurance user data, and calculates risk data corresponding to each selected risk category label based on the value.

S66. The second server generates an auto insurance dedicated score corresponding to the auto insurance user data based on the risk data.

In this embodiment, the second server can integrate and classify stored or obtained personal attribute variables, to generate a plurality of types of risk labels. These risk labels can be provided for an insurance company for selection. Each insurance company can select a required type of risk label based on its own vehicle operation policy, so that the second server can generate auto insurance dedicated scores for different insurance companies or more specifically for different auto insurance businesses.

In a specific example, the risk category label selected by an insurance company is a driving habit, an identity characteristic, a credit history, and a consumption level. Risk data obtained by calculating a personal attribute variable included in each risk category label is respectively good, healthy, excellent, and 8000. The risk data is converted to corresponding values: 80, 90, 95, and 80, and then the values are summed up to obtain an auto insurance dedicated score 345. Certainly, the second server can also directly calculate and output a value corresponding to each risk category label, for example, risk data corresponding to a driving habit, an identity characteristic, a credit history, and a consumption level is respectively 80, 90, 95, and 80, and then, adds up the values or performs calculation by using another method such as weighting, to obtain an auto insurance dedicated score.

Further, the method can include: S68. The second server returns the auto insurance dedicated score to the first server.

Certainly, further, the first server can determine a corresponding auto insurance business operation scheme based the auto insurance dedicated score, for example, whether an undertaking service is handled with or whether there is a discount for a premium.

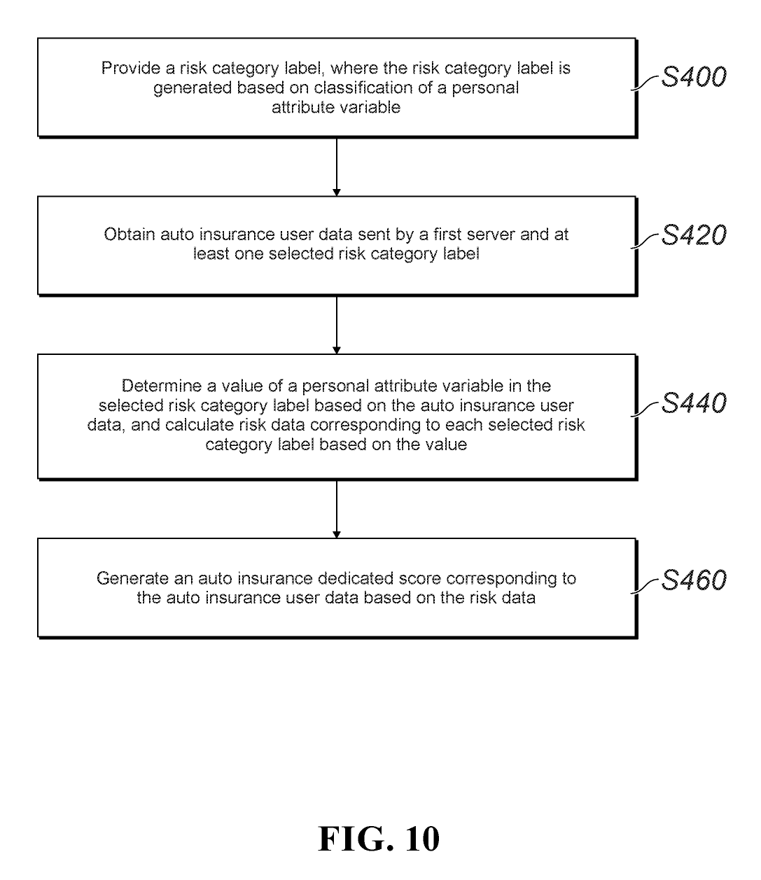

Similarly, based on descriptions of the embodiment of auto insurance business data exchange processing between the first server and the second server, the present application further provides a data processing method for an auto insurance business that can be used for the second server (for example, an organization that provides an auto insurance dedicated score service). FIG. 10 is a schematic flowchart illustrating another data processing method for an auto insurance business that can be used for a second server, according to the present application. As shown in FIG. 10, the method can include the following steps:

S400. Provide a risk category label, where the risk category label is generated based on classification of a personal attribute variable.

S420. Obtain auto insurance user data sent by a first server and at least one selected risk category label.

S440. Determine a value of a personal attribute variable in the selected risk category label based on the auto insurance user data, and calculate risk data corresponding to each selected risk category label based on the value.

S460. Generate an auto insurance dedicated score corresponding to the auto insurance user data based on the risk data.

As described previously, after generating the auto insurance dedicated score by means of calculation, the second server can return the auto insurance dedicated score to the first server, so that the first server determines a corresponding auto insurance business operation scheme based on the auto insurance dedicated score. Therefore, the method can further include: S480. Return the auto insurance dedicated score to the first server.

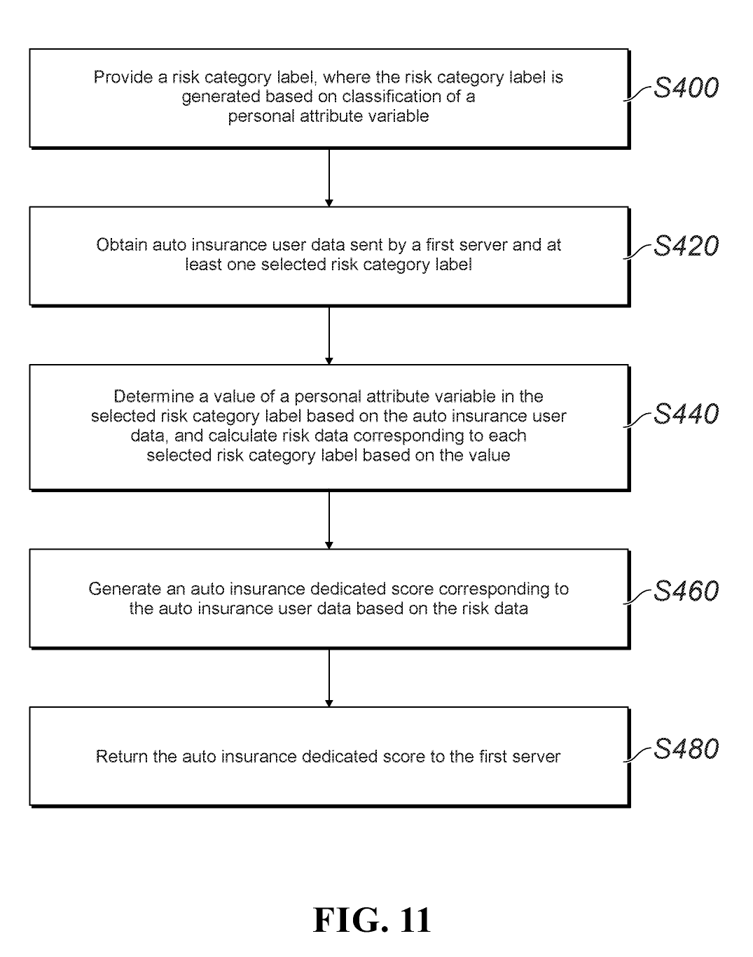

FIG. 11 is a schematic flowchart illustrating another data processing method for an auto insurance business that can be used for a second server, according to the present application. In another embodiment, an auto insurance dedicated score generated by a second server can also be returned to a first server by means of offline asynchronous transmission or real-time transmission. Specifically, the auto insurance dedicated score can be returned to the first server by using at least one of the following methods: storing the auto insurance dedicated score in a specified position, and providing an interface that is used by the first server to call the auto insurance dedicated score, and correspondingly, obtaining, by the first server, the auto insurance dedicated score by calling the interface; or sending the generated auto insurance dedicated score to the first server in real time.

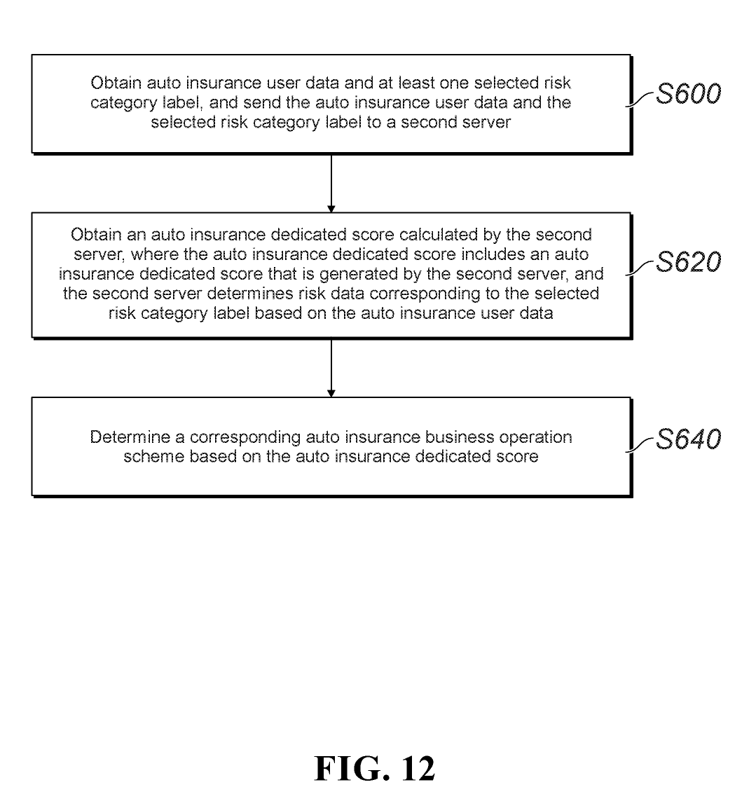

Similarly, based on descriptions of the embodiment of auto insurance business data exchange processing between the first server and the second server, the present application further provides a data processing method for an auto insurance business that can be used for the first server (for example, a server of an insurance company). FIG. 12 is a schematic flowchart illustrating another data processing method for an auto insurance business that can be used for a first server, according to the present application. As shown in FIG. 12, the method can include the following steps:

S600. Obtain auto insurance user data and at least one selected risk category label, and send the auto insurance user data and the selected risk category label to a second server.

S620. Obtain an auto insurance dedicated score calculated by the second server, where the auto insurance dedicated score includes an auto insurance dedicated score that is generated by the second server, and the second server determines risk data corresponding to the selected risk category label based on the auto insurance user data.

S640. Determine a corresponding auto insurance business operation scheme based on the auto insurance dedicated score.

Specific embodiments of the present specification have been described above. Other embodiments are within the scope of the appended claims. In some cases, actions or steps described in the claims can be performed in a sequence different from that in the embodiments and the desired result can still be obtained. In addition, the process described in the accompanying drawings does not necessarily require a specific order or sequence to obtain the desired result. In some implementations, multitasking and parallel processing are also feasible or may be advantageous.

In the data processing method for an auto insurance business provided in the embodiments mentioned above, some attribute information of a person, such as an identity characteristic, a credit history, a driving habit, and income stability are used, so that a unified standard score can be output after quantization. An insurance company can use the standard score to model and apply it to an auto insurance underwriting and pricing process, making an output auto insurance business operation scheme more accurate. For the same data processing object such as attribute information of a same person, the auto insurance standard score provided in the present application can be uniformly output to various insurance companies, providing the industry with a reference standard that is commonly used by different insurance companies when they formulate auto insurance operation services, narrowing the gap in the insurance companies' service standards when they formulate auto insurance businesses for consumers, and promoting the fair and healthy development in the industry.

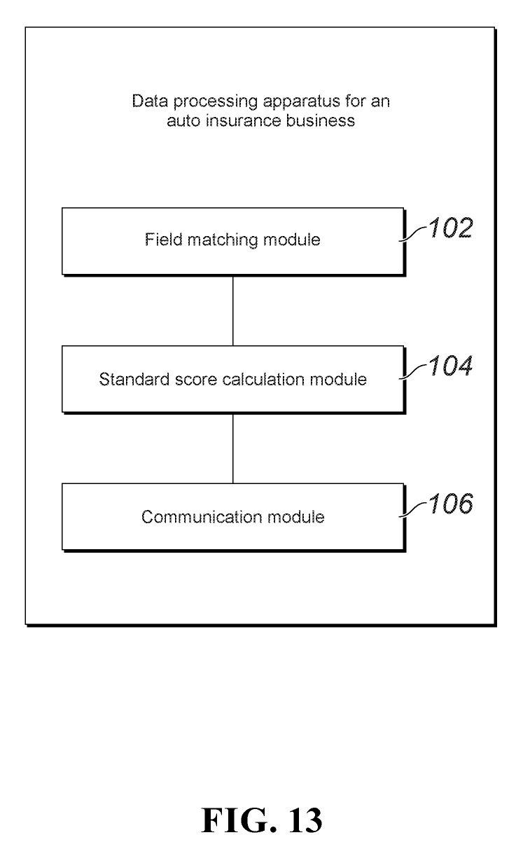

Based on the data processing method for an auto insurance business, the present application further provides a data processing apparatus for an auto insurance business. The apparatus can include a system (including a distributed system), software (an application), a module, a component, a server, a client, etc. that use the method described herein in combination with the necessary hardware to implement the apparatus. Based on a same innovative idea, an apparatus in an embodiment provided in the present application is described in the following embodiments. Because an implementation solution of resolving a problem by using the apparatus is similar to that of the method, for specific apparatus implementation in the present application, reference can be made to implementation of the method mentioned above, and details are not repeated here again. Terms “unit” or “module” used below can be a combination of software and/or hardware that implements a predetermined function. Although the apparatus described in the following embodiment is preferably implemented as software, implementation of hardware or a combination of software and hardware may also be conceived. Specifically, FIG. 13 is a schematic module structure diagram of an embodiment of a data processing apparatus for an auto insurance business, according to the present application. As shown in FIG. 13, the apparatus can include: a field matching module 102, configured to obtain a predetermined field of an auto insurance user, and obtain, by means of matching, a personal attribute variable of the auto insurance user and a value corresponding to the personal attribute variable based on the predetermined field; a standard score calculation module 104, configured to generate an auto insurance standard score by using a predetermined calculation method based on the personal attribute variable and the corresponding value; and a communication module 106, configured to send the auto insurance standard score to a first server.

In an embodiment of the present application, the predetermined calculation method of the auto insurance standard score can be set to be globally unique, that is, the second server uses a uniform and stable auto insurance standard score calculation method. In this way, for a same auto insurance user, auto insurance standard scores returned by the second server by means of calling to different insurance companies are consistent. In another embodiment of the apparatus, the predetermined calculation method used by the standard score calculation module 104 can be set to be globally unique.

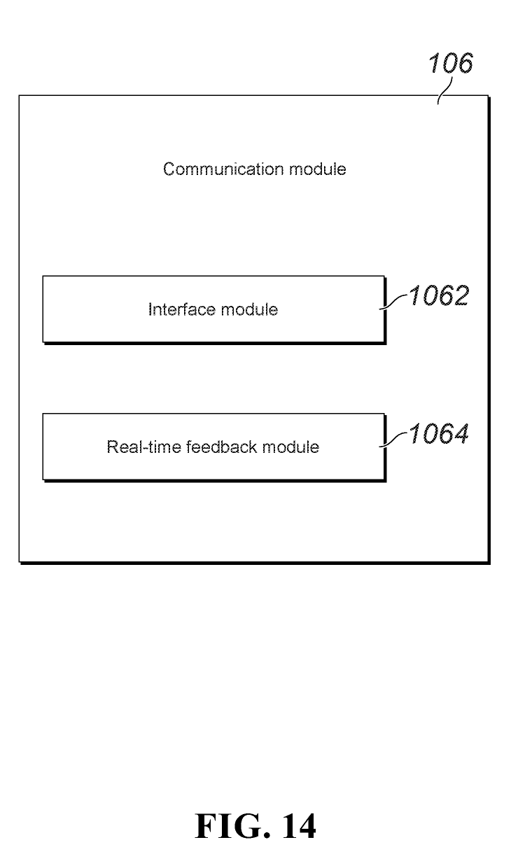

FIG. 14 is a schematic module structure diagram of an embodiment of the communication module in the apparatus, according to the present application. As shown in FIG. 14, in another embodiment, the communication module 106 includes at least one of the following: an interface module 1062, configured to store the auto insurance standard score in a specified position, and provide an interface that is used by the first server to call the auto insurance standard score, where the first server correspondingly obtains the auto insurance standard score by calling the interface; or a real-time feedback module 1064, configured to send the generated auto insurance standard score to the first server in real time.

The apparatus can provide two auto insurance standard score processing methods: offline scoring and online real-time scoring. Specific implementation of offline scoring can include: an insurance company uploads policy data of the auto insurance user in advance, and the apparatus performs calculation and scoring in advance, to obtain an auto insurance standard score of the auto insurance user. Then, a scoring result can be stored in a designated database table (such as a distributed database), and the scoring result is deployed online. In this way, the insurance company can call the auto insurance standard score of the auto insurance user by using a pre-determined interface. Offline scoring can be understood as a processing method of transmitting the scoring result to the first server in one step. In an implementation of online real-time scoring, specific implementation can include: deploying scoring logic of the auto insurance standard score and putting the scoring logic online. The first server can input a predetermined field required for scoring, and can obtain, in real time, the auto insurance standard score calculated by the apparatus.

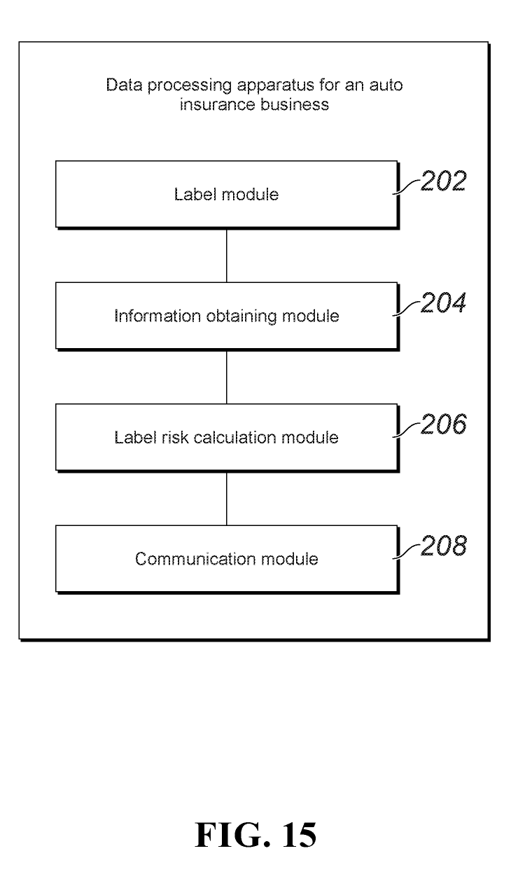

Based on the descriptions in the method embodiment mentioned above, the present application further provides another data processing apparatus for an auto insurance business. The apparatus can be used in a service system that provides an auto insurance risk assessment service (for example, the aforementioned second server). Specifically, FIG. 15 is a schematic module structure diagram of an embodiment of another data processing apparatus for an auto insurance business, according to the present application. As shown in FIG. 15, the apparatus can include: a label module 202, configured to provide a risk category label, where the risk category label is generated based on classification of a personal attribute variable; an information obtaining module 204, configured to obtain auto insurance user data sent by a first server and at least one selected risk category label; a label risk calculation module 206, configured to determine a value of a personal attribute variable in the selected risk category label based on the auto insurance user data, and calculate risk data corresponding to each selected risk category label based on the value; and a communication module 208, configured to return the risk data to the first server.

The label module 202 can provide a plurality of types of risk category labels, so that an insurance company worker selects one or more label combinations based on a service requirement of the insurance company, to determine an auto insurance dedicated score that is suitable for a service of the insurance company. Therefore, in another embodiment of the apparatus, the label category label provided by the label module can include at least one of the following types: a driving habit, an occupational characteristic, an identity characteristic, a credit history, a consumption habit, and stability.

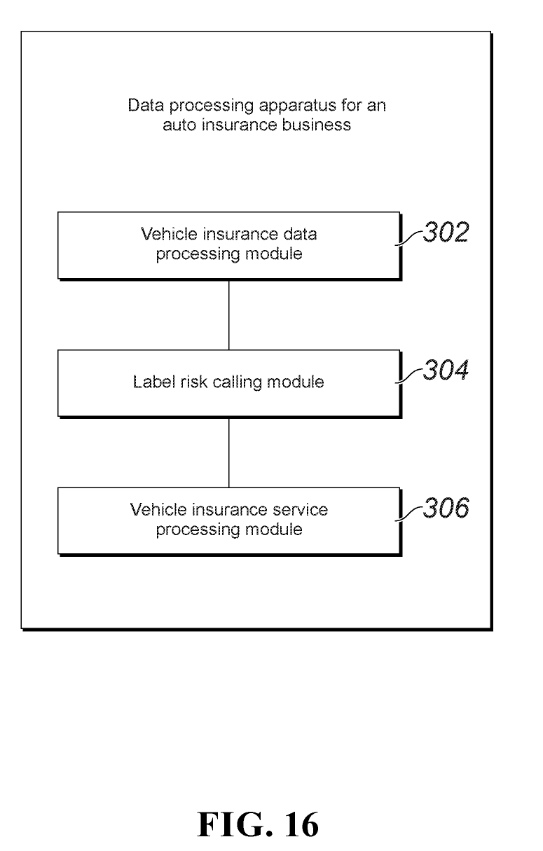

Based on the descriptions in the method embodiment mentioned above, the present application further provides another data processing apparatus for an auto insurance business. The apparatus can be used by an insurance company (for example, the aforementioned first server) to formulate an auto insurance operation scheme. Specifically, FIG. 16 is a schematic module structure diagram of an embodiment of a data processing apparatus for an auto insurance business, according to the present application. As shown in FIG. 16, the apparatus can include: an auto insurance data processing module 302, configured to obtain auto insurance user data and at least one selected risk category label, and send the auto insurance user data and the selected risk category label to a second server; a label risk calling module 304, configured to obtain risk data of the selected risk category label, where obtained risk data is calculated by the second server, and generate an auto insurance dedicated score corresponding to the auto insurance user data based on the risk data; and an auto insurance business processing module 306, configured to determine a corresponding auto insurance business operation scheme based on the auto insurance dedicated score.

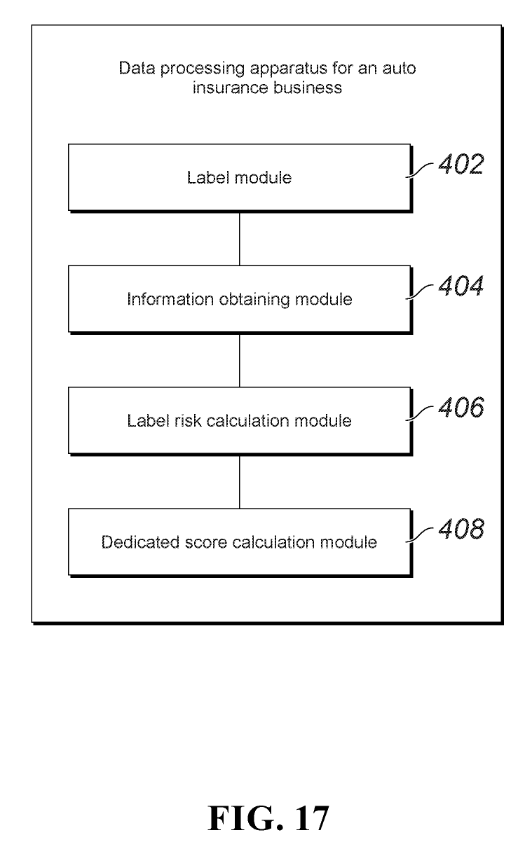

The present application provides another data processing apparatus for an auto insurance business that can be used for an auto insurance risk assessment service side. FIG. 17 is a schematic module structure diagram of an embodiment of a data processing apparatus for an auto insurance business, according to the present application. The apparatus can include: a label module 402, configured to provide a risk category label, where the risk category label is generated based on classification of a personal attribute variable; an information obtaining module 404, configured to obtain auto insurance user data sent by a first server and at least one selected risk category label; a label risk calculation module 406, configured to determine a value of a personal attribute variable in the selected risk category label based on the auto insurance user data, and calculate risk data corresponding to each selected risk category label based on the value; and a dedicated score calculation module 408, configured to generate an auto insurance dedicated score corresponding to the auto insurance user data based on the risk data.

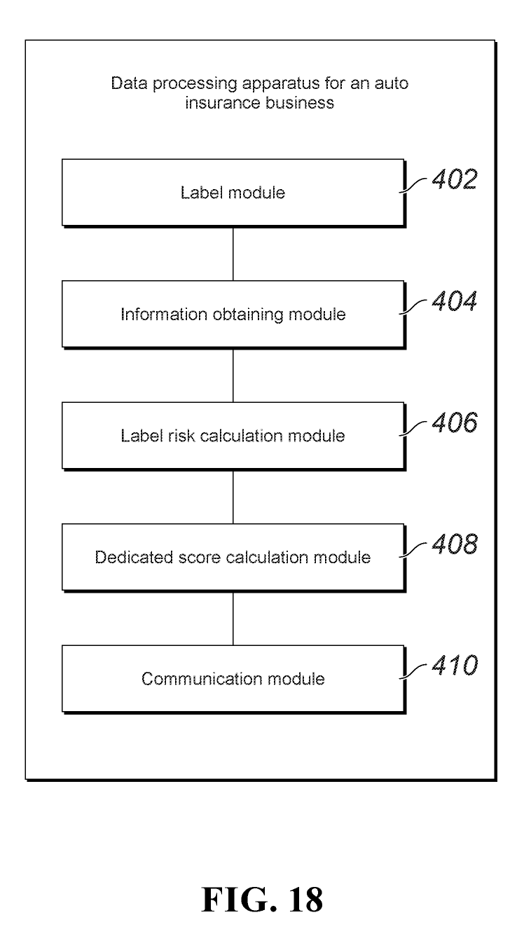

In another embodiment of the apparatus, as shown in FIG. 18, FIG. 18 is a schematic module structure diagram of an embodiment of a data processing apparatus for an auto insurance business, according to the present application. The apparatus further includes: a communication module 410, configured to return the auto insurance dedicated score to the first server, so that the first server determines a corresponding auto insurance business operation scheme based on the auto insurance dedicated score.

Certainly, with reference to the descriptions in the previous embodiments related to the method or the apparatus, the communication module 410 can include at least one of the following: an interface module 412, configured to store the auto insurance dedicated score in a specified position, and provide an interface that is used by the first server to call the auto insurance dedicated score, where the first server correspondingly obtains the auto insurance dedicated score by calling the interface; or a real-time feedback module 414, configured to send the generated auto insurance dedicated score to the first server in real time.

In another embodiment, the label category label provided by the label module 402 can include at least one of the following types: a driving habit, an occupational characteristic, an identity characteristic, a credit history, a consumption habit, and stability.

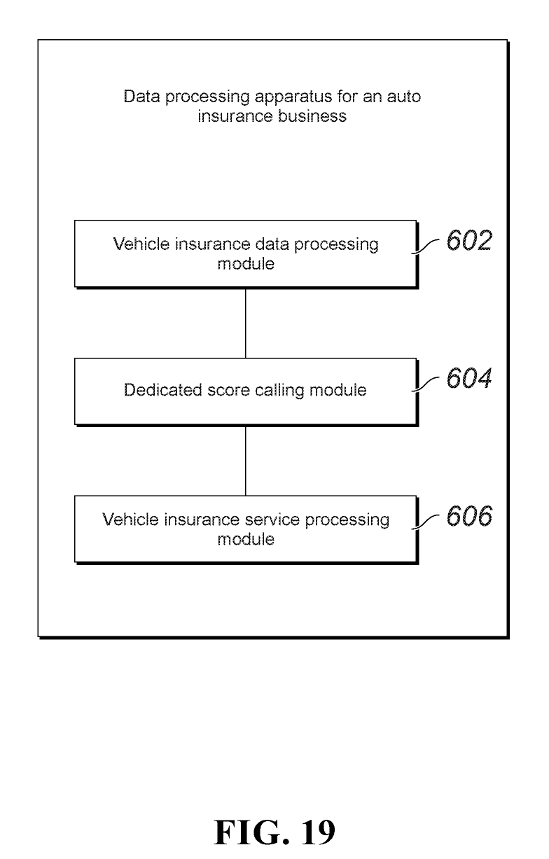

Based on the descriptions in the method embodiment mentioned above, the present application further provides another data processing apparatus for an auto insurance business. The apparatus can be used by an insurance company (for example, the aforementioned first server) to formulate an auto insurance operation scheme. Specifically, FIG. 19 is a schematic module structure diagram of an embodiment of a data processing apparatus for an auto insurance business, according to the present application. As shown in FIG. 19, the apparatus can include: an auto insurance data processing module 602, configured to obtain auto insurance user data and at least one selected risk category label, and send the auto insurance user data and the selected risk category label to a second server; a dedicated score calling module 604, configured to obtain an auto insurance dedicated score calculated by the second server, where the auto insurance dedicated score includes an auto insurance dedicated score that is generated by the second server, and the second server determines risk data corresponding to the selected risk category label based on the auto insurance user data; and an auto insurance business processing module 606, configured to determine a corresponding auto insurance business operation scheme based on the auto insurance dedicated score.

In the apparatus embodiment mentioned above, stored or obtained personal attribute variables can be integrated and classified, to generate a plurality of types of risk labels. These risk labels can be provided for an insurance company for selection. Each insurance company can select a required type of risk label based on its auto insurance business operation policy, so that a server that provides scoring or a server on an insurance company side can generate auto insurance dedicated scores for different insurance companies or more specifically for different auto insurance businesses.

It should be noted that the apparatus mentioned above can further include another implementation based on descriptions in the method embodiments. For a specific implementation, reference can be made to descriptions in the relevant method embodiments, which is not described herein again.

The present application provides a data processing apparatus for an auto insurance business, and some attribute information related to a person, such as a physical feature (such as an age, a medical history, etc.), a credit history, and a driving habit are used, so that a unified standard score can be output after quantization. An insurance company can use the standard score to model and apply it to an auto insurance underwriting and pricing process, making an output auto insurance business operation scheme more accurate. For the same data processing object such as attribute information of a same person, the auto insurance standard score provided in the present application can be uniformly output to various insurance companies, providing the industry with a reference standard that is commonly used by different insurance companies when they formulate auto insurance operation services, narrowing the gap in the insurance companies' service standards when they formulate auto insurance businesses for consumers, and promoting the fair and healthy development in the industry.

The data processing method or apparatus for an auto insurance business provided in the present application can be implemented in a computer by a processor by executing a corresponding program instruction. For example, it can be implemented at a PC end by using a C++ language of a Windows operating system, or implemented by using a corresponding program design language in another system such as Linux, Android, and iOS. In another embodiment of the data processing apparatus for an auto insurance business provided in the present application, a terminal/system that can be used for auto insurance risk assessment includes a processor and a memory that is configured to store a processor-executable instruction, and when executing the instruction, the processor implements the following operations: obtaining a predetermined field of an auto insurance user, and obtaining, by means of matching, a personal attribute variable of the auto insurance user and a value corresponding to the personal attribute variable based on the predetermined field; generating an auto insurance standard score by using a predetermined calculation method based on the personal attribute variable and the corresponding value; and sending the auto insurance standard score to a first server.

In another embodiment, the data processing apparatus for an auto insurance business can include a processor and a memory that is configured to store a processor-executable instruction, and when executing the instruction, the processor implements the following operations: providing a risk category label, where the risk category label is generated based on classification of a personal attribute variable; obtaining auto insurance user data sent by a first server and at least one selected risk category label; determining a value of a personal attribute variable in the selected risk category label based on the auto insurance user data, and calculating risk data corresponding to each selected risk category label based on the value; and returning the risk data to the first server.

Another data processing apparatus for an auto insurance business provided in the present application can include a processor and a memory that is configured to store a processor-executable instruction, and when executing the instruction, the processor implements the following operations: providing a risk category label, where the risk category label is generated based on classification of a personal attribute variable; obtaining auto insurance user data sent by a first server and at least one selected risk category label; determining a value of a personal attribute variable in the selected risk category label based on the auto insurance user data, and calculating risk data corresponding to each selected risk category label based on the value; and generating an auto insurance dedicated score corresponding to the auto insurance user data based on the risk data.

Certainly, for an insurance company side, the present application can provide a data processing apparatus for an auto insurance business that is used on the insurance company side.

Specifically, the apparatus can include a processor and a memory that is configured to store a processor-executable instruction, and when executing the instruction, the processor implements the following operations: obtaining auto insurance user data and at least one selected risk category label, and sending the auto insurance user data and the selected risk category label to a second server; obtaining risk data, calculated by the second server, of the selected risk category label, and generating an auto insurance dedicated score corresponding to the auto insurance user data based on the risk data; and determining a corresponding auto insurance business operation scheme based on the auto insurance dedicated score.

Alternatively, in another embodiment, the data processing apparatus for an auto insurance business can include a processor and a memory that is configured to store a processor-executable instruction, and when executing the instruction, the processor implements the following operations: obtaining auto insurance user data and at least one selected risk category label, and sending the auto insurance user data and the selected risk category label to a second server; obtaining an auto insurance dedicated score calculated by the second server, where the auto insurance dedicated score includes an auto insurance dedicated score that is generated by the second server, and the second server determines risk data corresponding to the selected risk category label based on the auto insurance user data; and determining a corresponding auto insurance business operation scheme based on the auto insurance dedicated score.

The present application further provides an auto insurance risk assessment system, and the system can include a processor and a memory that is configured to store a processor-executable instruction. When executing the instruction, the processor implements steps of any method according to the present application. Alternatively, the system can include any one of the apparatuses provided in the present application. The system can be a service organization that provides auto insurance risk assessment for an insurance company, for example, a system/an application that provides an auto insurance standard score service or an auto insurance dedicated score service, and can connect to the insurance company and be used as an ally of the insurance company or a partner of third-party auto insurance business operation. For example, providing offline or online scoring result outputting. Alternatively, the system can also directly connect to a service system of an insurance company, and is used as a part of auto insurance business operation of the insurance company.

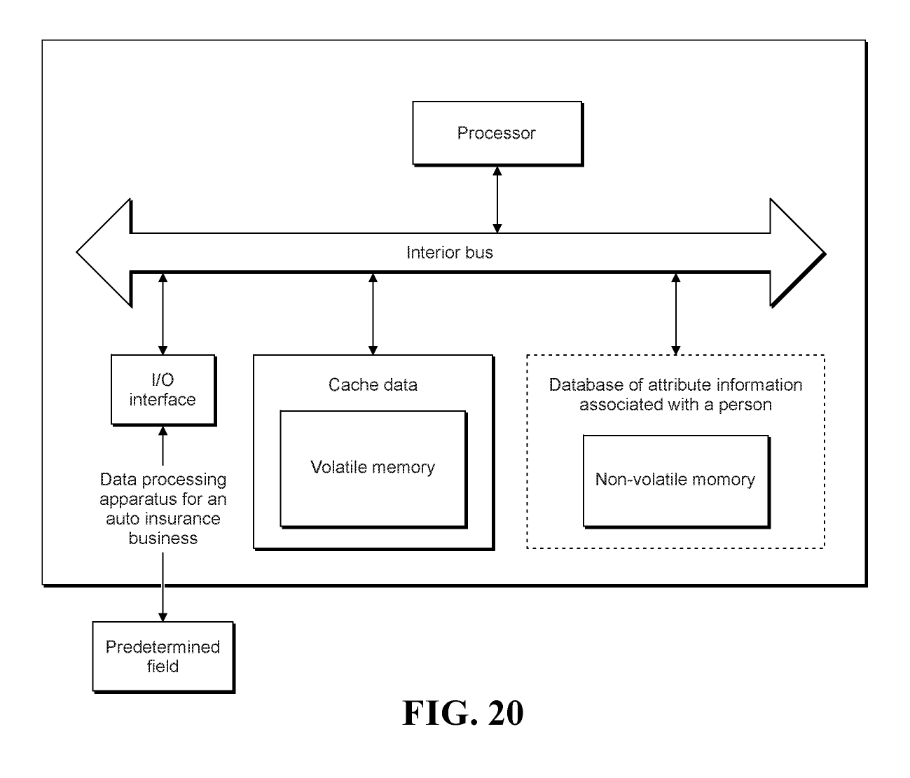

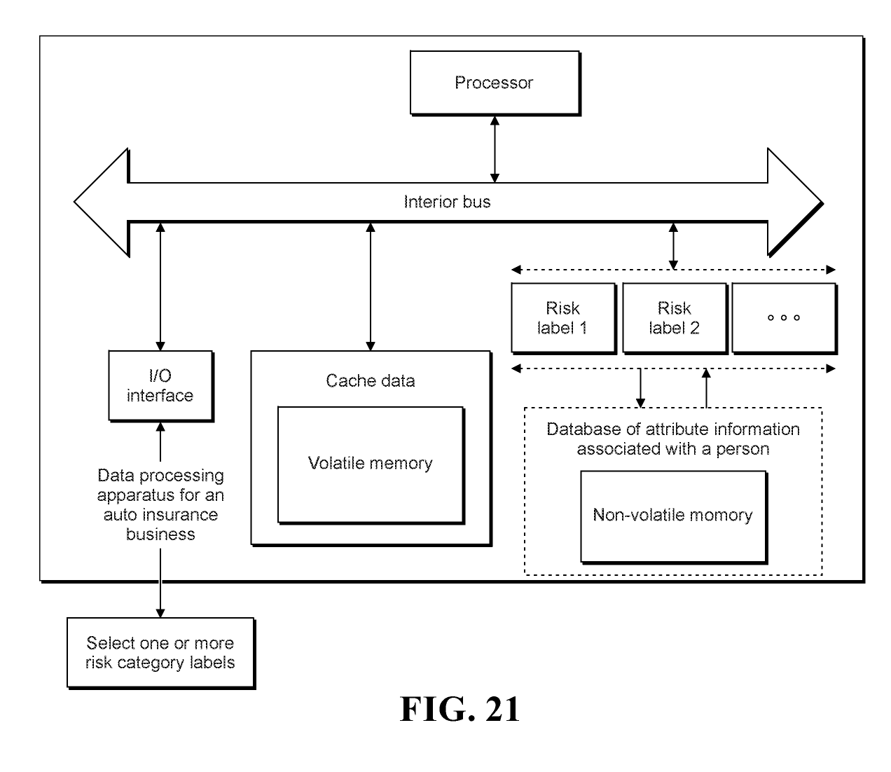

The data processing apparatus for an auto insurance business provided in this embodiment of the present application can be applied to a plurality of systems (including a distributed system), software (an application), a module, a component, a server, a client, etc. that use the methods described here, in combination with the necessary hardware to implement the apparatus. FIG. 20 is a schematic structural diagram illustrating that a data processing apparatus for an auto insurance business is applied to a server, according to the present application. FIG. 21 is a schematic structural diagram illustrating that another data processing apparatus for an auto insurance business is applied to a server, according to the present application. Specifically, in an actual terminal device, the apparatus shown in FIG. 20 or FIG. 21 can be a server or a terminal application that provides auto insurance risk identification/assessment.

The present application provides a data processing method, apparatus, and system for an auto insurance business, and some attribute information related to a person, such as a physical feature (such as an age, a medical history, etc.), a credit history, and a driving habit are used, so that a unified standard score can be output after quantization. An insurance company can use the standard score to model and apply it to an auto insurance underwriting and pricing process, making an output auto insurance business operation scheme more accurate. For the same data processing object such as attribute information of a same person, the auto insurance standard score provided in the present application can be uniformly output to various insurance companies, providing the industry with a reference standard that is commonly used by different insurance companies when they formulate auto insurance operation services, narrowing the gap in the insurance companies' service standards when they formulate auto insurance businesses for consumers, and promoting the fair and healthy development in the industry.

Although definition of a predetermined field, a label classification method, a personal attribute variable obtaining method and a value conversion method, a data storage method, and descriptions of data/definition, obtaining, interaction, calculation, determining, etc. of asynchronous or real-time data exchange between a first server and a second server are mentioned in content of the present application, the present application is not necessarily limited to cases that conform to an industry communications standard and standard computer data processing and storage rules, or the cases described in the embodiments of the present application. An implementation solution obtained after making slight modification based on some industry standards, or by using a self-defined method, or based on implementation described in the embodiments can also achieve an implementation effect that is the same as, equivalent to, or similar to the embodiments mentioned above or that can be predicted after transformation. An embodiment obtained after using a data obtaining, storage, determining, and processing method obtained after such modification or transformation is still within the scope of optional implementation solutions of the present application.

Specific embodiments of the present specification are described previously. Other embodiments are within the scope of the appended claims. In some cases, actions or steps described in the claims can be performed in a sequence different from that in the embodiments and the desired result can still be obtained. In addition, the process described in the accompanying drawings does not necessarily require a specific order or sequence to obtain the desired result. In some implementations, multitask and parallel processing are also feasible or may be advantageous.

In the 1990s, improvement of a technology can be clearly distinguished between hardware improvement (for example, improvement on a circuit structure such as a diode, a transistor, or a switch) and software improvement (improvement on a method procedure). However, with the development of technologies, improvement of many method processes can be considered as a direct improvement of a hardware circuit structure. Designers almost all program an improved method procedure to a hardware circuit, to obtain a corresponding hardware circuit structure. Therefore, it cannot be said that an improvement of a method procedure cannot be implemented by using a hardware entity module. For example, a programmable logic device (PLD) (for example, a field programmable gate array (FPGA)) is a type of an integrated circuit. A logical function of the programmable logic device is determined by component programming executed by a user. The designers perform voluntary programming to “integrate” a digital system into a single PLD without requiring a chip manufacturer to design and produce a dedicated integrated circuit chip. In addition, instead of manually producing an integrated circuit chip, the programming is mostly implemented by “logic compiler” software, which is similar to a software compiler used during program development. Original code before compiling is also written in a specific programming language, which is referred to as a hardware description language (HDL), and there is more than one type of HDL, such as an ABEL (Advanced Boolean Expression Language), an AHDL (Altera Hardware Description Language), Confluence, a CUPL (Cornell University Programming Language), an HDCal, a JHDL (Java Hardware Description Language), a Lava, a Lola, a MyHDL, a PALASM, and an RHDL (Ruby Hardware Description Language), etc. Currently, VHDL (Very-High-Speed Integrated Circuit Hardware Description Language) and Verilog are most commonly used. A person skilled in the art should also understand that a method procedure only needs to be logically programmed, and programmed to the integrated circuit by using the foregoing hardware description languages, so that a hardware circuit that implements the logical method process can be easily obtained.

The controller can be implemented in any suitable manner. For example, the controller can be a microprocessor or a processor, or a computer-readable medium, a logic gate, a switch, an application-specific integrated circuit (ASIC), a programmable logic controller, or an embedded microprocessor that stores computer readable program code (such as software or firmware) that can be executed by the microprocessor or the processor. Examples of the controller include, but are not limited to, the following microprocessors: ARC 625D, Atmel AT91SAM, Microchip PIC18F26K20, and Silicone Labs C8051F320. The memory controller can also be implemented as a part of the control logic of the memory. A person skilled in the art also knows that a controller can be implemented in a manner of pure computer-readable program code, and the steps in the method can be logically programmed to enable the controller to further implement same functions in forms of a logic gate, a switch, an application-specific integrated circuit, a programmable logic controller, an embedded microcontroller, etc. Therefore, the controller can be considered as a hardware component, and an apparatus that is included in the controller and that is configured to implement various functions can also be considered as a structure in the hardware component. Alternatively, an apparatus configured to implement various functions can be considered as both a software module for implementing the method and a structure in the hardware component.

The system, the apparatus, the module, or the unit described in the foregoing embodiments can be specifically implemented by a computer chip or an entity, or implemented by a product with a particular function. A typical implementation device is a computer. Specifically, the computer can be, for example, a personal computer, a laptop computer, a vehicle-mounted human computer interaction device, a cellular phone, a camera phone, a smart phone, a personal digital assistant (PDA), a media player, a navigation device, an email device, a game controller, a tablet computer, a wearable device, or a combination of any of these devices.

Although the present application provides the operational steps of the method in an embodiment or a flowchart, more or fewer operational steps can be included based on the conventional or non-creative means. The sequence of steps enumerated in the embodiments is merely one of a plurality of step execution sequences, and does not represent a unique execution sequence. In practice, when an apparatus or a terminal product executes steps, the execution can be performed in a sequence shown in an embodiment or a method shown in the accompanying drawing, or performed in parallel (for example, in an environment of processing in parallel, in a multithreaded processing environment, and even in a distributed data processing environment). The terms “include”, “comprise”, or any other variants are intended to cover a non-exclusive inclusion, so that a process, a method, a product, or a device that includes a list of elements not only includes those elements, but also includes other elements which are not expressly listed, or further includes elements inherent to such process, method, product, or device. When there are no more restrictions, it is also possible that there is another same or equivalent element in the process, the method, a product, or a device that includes the element

For ease of description, the foregoing apparatus is described by dividing the functions into various modules. Certainly, when implementing the present application, a function of each module can be implemented in one or more pieces of software and/or hardware, or a module that implements the same function can be implemented as a combination of a plurality of submodules or subunits. The described apparatus embodiment is merely an example. For example, the unit division is merely logical function division and can be other division in actual implementation. For example, a plurality of units or components can be combined or integrated into another system, or some features can be ignored or not performed. In addition, the displayed or discussed mutual couplings or direct couplings or communication connections can be implemented by using some interfaces. The indirect couplings or communication connections between the apparatuses or units can be implemented in electronic, mechanical, or other forms.

A person skilled in the art also knows that a controller can be implemented in a manner of pure computer-readable program code, and the steps in the method can be logically programmed to enable the controller to further implement same functions in forms of a logic gate, a switch, an application-specific integrated circuit, a programmable logic controller, an embedded microcontroller, etc. Therefore, the controller can be considered as a hardware component, and an apparatus that is included in the controller and that is configured to implement various functions can also be considered as a structure in the hardware component. Alternatively, an apparatus configured to implement various functions can be considered as both a software module for implementing the method and a structure in the hardware component.

The present disclosure is described with reference to the flowcharts and/or block diagrams of the method, the device (system), and the computer program product based on the embodiments of the present disclosure. It should be understood that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions can be stored in a computer-readable memory that can instruct the computer or the any other programmable data processing device to work in a specific manner, so that the instructions stored in the computer-readable memory can generate an artifact that includes an instruction apparatus. The instruction apparatus implements a specific function in one or more processes in the flowcharts and/or in one or more blocks in the block diagrams.

These computer program instructions can be loaded onto the computer or the another programmable data processing device, so that a series of operations and steps are performed on the computer or the another programmable device, thereby generating computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPU), an input/output interface, a network interface, and a memory.

The memory includes a non-persistent memory, a random access memory (RAM), and/or a non-volatile memory in a computer-readable medium, for example, a read-only memory (ROM) or a flash memory (flash memory). The memory is an example of the computer-readable medium.

The computer-readable medium includes persistent, non-persistent, movable, and unmovable media that can implement information storage by using any method or technology. Information can be a computer-readable instruction, a data structure, a program module, or other data. Examples of the computer storage medium include but are not limited to a phase change memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a tape and disk storage or another magnetic storage device, or any other non-transmission media that can be configured to store information that a computing device can access. As defined in the present specification, the computer-readable medium does not include a transitory medium, such as a modulated data signal and carrier.

A person skilled in the art should understand that the embodiments of the present application can be provided as a method, a system, or a computer program product. Therefore, the present application can use a form of hardware only embodiments, software only embodiments, or embodiments with a combination of software and hardware. Moreover, the present application can use a form of a computer program product that is implemented on one or more computer-usable storage media (including but not limited to a disk memory, a CD-ROM, an optical memory, etc.) that include computer-usable program code.

The present application can be described in the general context of computer executable instructions executed by a computer, for example, a program module. Generally, the program module includes a routine, a program, an object, a component, a data structure, etc. for executing a particular task or implementing a particular abstract data type. The present application can also be practiced in distributed computing environments in which tasks are performed by remote processing devices that are connected by using a communications network. In a distributed computing environment, the program module can be located in both local and remote computer storage media including storage devices.

The embodiments in the present specification are all described in a progressive manner, for the same or similar parts in the embodiments, reference can be each other, and each embodiment focuses on a difference from other embodiments. Particularly, since a system embodiment is similar to a method embodiment, and therefore is described briefly; and for the relevant parts, reference can be made to partial descriptions of the method embodiment. In the descriptions of this specification, reference terms as “an embodiment”, “some embodiments”, “an example”, “a specific example”, or “some examples” mean that specific features, structures, materials, or characteristics described with reference to the embodiments or examples are included in at least one embodiment or example of the present application. In this specification, the foregoing terms are described not necessarily for the same embodiment or example. In addition, the described specific features, structures, materials, or characteristics can be combined in a proper manner in any one or more of the embodiments or examples. In addition, a person skilled in the art can combine different embodiments or examples described in this specification and features of different embodiments or examples without mutual contradiction.

The foregoing descriptions are merely embodiments of the present application, and are not intended to limit the present application. For a person skilled in the art, the present application can have various changes and variations. Any modifications, equivalent replacements, or improvements made within the spirit and principle of the present application shall fall within the scope of the claims in the present application.

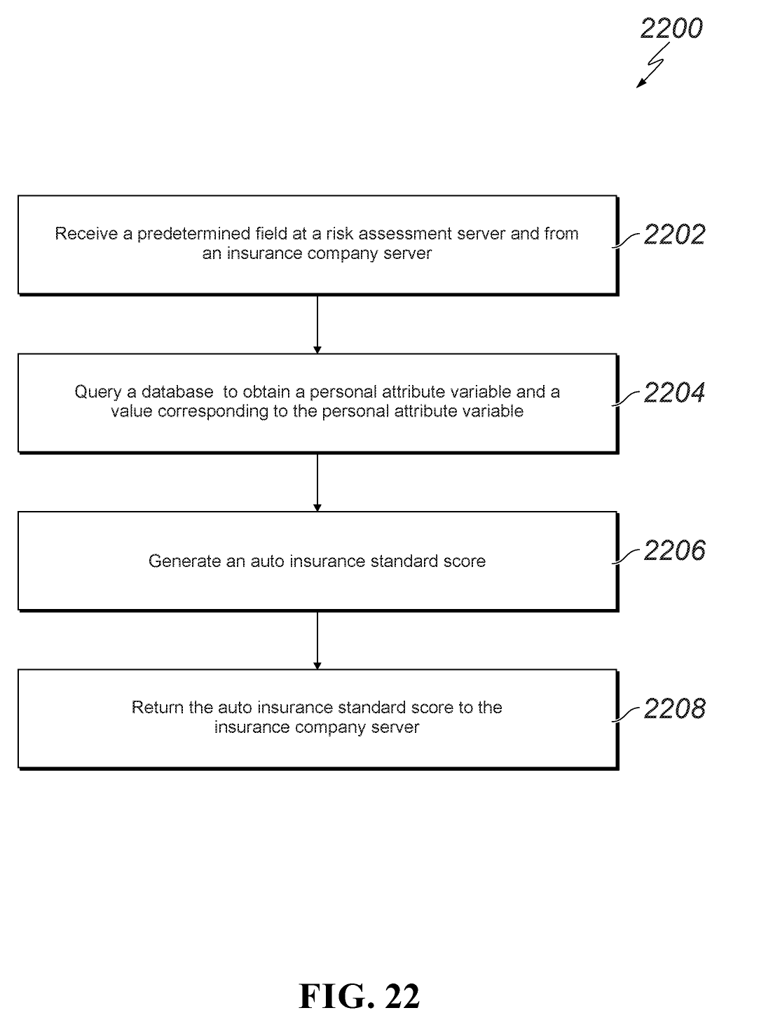

FIG. 22 is a flowchart illustrating an example of a computer-implemented method 2200 for computer data processing, according to an implementation of the present disclosure. For clarity of presentation, the description that follows generally describes method 2200 in the context of the other figures in this description. However, it will be understood that method 2200 can be performed, for example, by any system, environment, software, and hardware, or a combination of systems, environments, software, and hardware, as appropriate. In some implementations, various steps of method 2200 can be run in parallel, in combination, in loops, or in any order.

At 2202, a predetermined field is received at a risk assessment server and from an insurance company server, where the predetermined field contains attribute information associated with an auto insurance user. In some implementations, the second server can pre-collect or record attribute information associated with the auto insurance user to determine the auto insurance standard score, where the attribute information is based on predetermined fields that need to be uploaded to the risk assessment server for determining the auto insurance score. In some implementations, at least one personal attribute variable can be set in the database with the pre-collected attribute information. In some implementations, the risk assessment server can receive a query from an insurance company server requesting one or more predetermined fields for the risk assessment server to determine the auto insurance standard score; and send the one or more predetermined fields to the risk assessment server. From 2202, method 2200 proceeds to 2204.

At 2204, a personal attribute variable and a value corresponding to the personal attribute variable are obtained by querying a database based on the predetermined field. In some implementations, the personal attribute variable can include a variable field that is set based on attribute information of a person, and the attribute information can specifically include a plurality of types of data information, such as self-physique information, social relationship information, personality information, social value information, driving behavior, etc.

In some implementation solutions, the value of the personal attribute variable can be further processed, so that the calculated auto insurance standard store is more intuitive and simple to show the level of risk. For example, the data conversion method can convert values of all or some personal attribute variables into the same order of magnitude. In this way, the final auto insurance standard score calculation result can more closely match the personal attribute variable, and it is also easier to be understood by the insurance company and the public. From 2204, method 2200 proceeds to 2206.

At 2206, an auto insurance standard score for the auto insurance user is generated by using a predetermined calculation method with the obtained personal attribute variable and the corresponding value of the personal attribute variable. In some implementations, the specific predetermined calculation method of the personal attribute and the value corresponding to such variable can be based on the applicant environment of the auto insurance business, to formulate a uniform calculation standard, which is applicable to each insurance company. The predetermined calculation method can include not only how to perform mathematical calculation among individual personal attribute variables, but can also include how to select attribute variables or a processing method/process of transforming, converting, or weighting the personal attribute variable. From 2206, method 2200 proceeds to 2208.

At 2206, the auto insurance standard score is returned to the insurance company server from the risk assessment server. In some implementation solutions, the insurance company server can use the auto insurance standard score returned by the risk assessment server as a basis for formulating the service operation scheme for the auto insurance user, and can finally determine the service operation scheme for the auto insurance user. For example, an insurance company can apply the obtained auto insurance standard score to the process of underwriting and pricing for auto insurance users. In this example, if the auto insurance standard score is relatively high, it can indicate that an auto insurance risk of the user is relatively small, and the user can get a discount based on the range of the auto insurance standard score. As a particular example, an offered discount can be set to be higher the greater the determined auto insurance standard score. After 2208, method 2200 stops.

Implementations of the present application can solve technical problems in determining a categorizing value based on processing attribute-type data. Traditionally, insurance companies rely mainly on the vehicle's own attribute information to formulate insurance policy schemes. However, if an auto insurance risk is assessed only based on the vehicle's attribute information, the assessment will have significant limitations and the risk identification will not be sufficiently compensated. As such, auto insurance underwriting and pricing accuracy of the insurance company is reduced. In addition, insurance companies use different auto insurance standard scores when formulating auto insurance operation services. Even for the same insured-vehicle information, due to differences in vehicle company background, service composition, market trends, etc., underwriter services provided by different insurance companies usually differ significantly. What is needed is a technique to bypass these problems in the conventional methods, and providing a more accurate and unified solution for determining a categorized value.

Implementation of the present application provide methods and apparatuses for improving data processing by determining a categorizing value based on processing attribute data in a centralized location. According to these implementations, in addition to the vehicle's attribute information, the present application also uses attribute information to a person (for example, physical feature, credit history, driving habit, etc.). Further, to-be-processed attribute data is selected based on each insurance company's needs, thereby improving the efficiency and accuracy of the subsequent data processing and a final auto insurance standard score. The selected data can be further processed (for example, normalization or processing of attribute data to a same order of magnitude) to increase, for example, computer memory utilization, data storage, computer processing by a microprocessor, or transmission across a network. Moreover, the auto insurance standard score associated with an auto insurance user is generated by using a predetermined calculation method (that is, a uniform calculation method(s)) for transforming, converting, or weighting the attribute data in the centralized location; resulting a more uniform categorized value. The centralized processing location can also be configured, for example, to save computer processing cycles, computer memory usage, and network bandwidth when compared to processing the described attribute-type data in multiple different locations and transmitting result data across a network(s) for subsequent processing to the centralized location.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method, comprising:
receiving at a risk assessment server and from an insurance company server, a predetermined field containing attribute information associated with an auto insurance user;
querying a database based on the predetermined field to obtain a personal attribute variable associated with the auto insurance user and a value corresponding to the personal attribute variable;
generating an auto insurance standard score for the auto insurance user using a predetermined calculation method with the obtained personal attribute variable and the corresponding value of the personal attribute variable; and
returning the auto insurance standard score to the insurance company server.

2. The computer-implemented method of claim 1, further comprising:
pre-collecting the attribute information associated with the auto insurance user to determine the auto insurance standard score, wherein the attribute information is based on predetermined fields that need to be uploaded to the risk assessment server for determining the auto insurance standard score; and
setting at least one personal attribute variable in the database with the pre-collected attribute information.

3. The computer-implemented method of claim 1, further comprising preprocessing the value corresponding to the personal attribute variable to a similar order of magnitude in relation to other values corresponding to other personal attribute variables.

4. The computer-implemented method of claim 1, further comprising:
receiving a query from an insurance company server requesting one or more predetermined fields required for the risk assessment server to determine the auto-insurance standard score; and
sending the one or more predetermined fields to the risk assessment server.

5. The computer-implemented method of claim 1, further comprising formulating the uniform calculation method to determine the auto insurance standard score, wherein an auto insurance standard score provided by the uniform calculation method is applicable to at least one insurance company.

6. The computer-implemented method of claim 1, wherein the predetermined calculation method can select personal attribute variables or a processing method for transforming, converting, or weighting the value corresponding to the personal attribute variable.

7. The computer-implemented method of claim 1, further comprising using, by the insurance company server, the auto insurance standard score to determine a value for an insurance policy.

8. A non-transitory, computer-readable medium storing one or more instructions executable by a computer system to perform operations comprising:
receive at a risk assessment server and from an insurance company server, a predetermined field containing attribute information associated with an auto insurance user;
query a database based on the predetermined field to obtain a personal attribute variable associated with the auto insurance user and a value corresponding to the personal attribute variable;
generate an auto insurance standard score for the auto insurance user using a predetermined calculation method with the obtained personal attribute variable and the corresponding value of the personal attribute variable; and
return the auto insurance standard score to the insurance company server.

9. The non-transitory, computer-readable medium of claim 8, further comprising one or more instructions to:
pre-collect the attribute information associated with the auto insurance user to determine the auto insurance standard score, wherein the attribute information is based on predetermined fields that need to be uploaded to the risk assessment server for determining the auto insurance standard score; and
set at least one personal attribute variable in the database with the pre-collected attribute information.

10. The non-transitory, computer-readable medium of claim 9, further comprising one or more instructions to preprocess the value corresponding to the personal attribute variable to a similar order of magnitude in relation to other values corresponding to other personal attribute variables.

11. The non-transitory, computer-readable medium of claim 10, further comprising one or more instructions to:
receive a query from an insurance company server requesting one or more predetermined fields required for the risk assessment server to determine the auto-insurance standard score; and
send the one or more predetermined fields to the risk assessment server.

12. The non-transitory, computer-readable medium of claim 11, further comprising one or more instructions to formulate the uniform calculation method to determine the auto insurance standard score, and wherein an auto insurance standard score provided by the uniform calculation method is applicable to at least one insurance company.

13. The non-transitory, computer-readable medium of claim 12, wherein the predetermined calculation method can select personal attribute variables or a processing method for transforming, converting, or weighting the value corresponding to the personal attribute variable.

14. The non-transitory, computer-readable medium of claim 13, further comprising one or more instructions to use, by the insurance company server, the auto insurance standard score to determine a value for an insurance policy.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving at a risk assessment server and from an insurance company server, a predetermined field containing attribute information associated with an auto insurance user;
querying a database based on the predetermined field to obtain a personal attribute variable associated with the auto insurance user and a value corresponding to the personal attribute variable;
generating an auto insurance standard score for the auto insurance user using a predetermined calculation method with the obtained personal attribute variable and the corresponding value of the personal attribute variable; and
returning the auto insurance standard score to the insurance company server.

16. The computer-implemented system of claim 15, further comprising one or more operations to:
pre-collect the attribute information associated with the auto insurance user to determine the auto insurance standard score, wherein the attribute information is based on predetermined fields that need to be uploaded to the risk assessment server for determining the auto insurance standard score; and
set at least one personal attribute variable in the database with the pre-collected attribute information.

17. The computer-implemented system of claim 16, further comprising one or more operations to preprocess the value corresponding to the personal attribute variable to a similar order of magnitude in relation to other values corresponding to other personal attribute variables.

18. The computer-implemented system of claim 17, further comprising one or more operations to:
receive a query from an insurance company server requesting one or more predetermined fields required for the risk assessment server to determine the auto-insurance standard score; and
send the one or more predetermined fields to the risk assessment server.

19. The computer-implemented system of claim 18, further comprising one or more operations to formulate the uniform calculation method to determine the auto insurance standard score, and wherein an auto insurance standard score provided by the uniform calculation method is applicable to at least one insurance company to determine a value for an insurance policy.

20. The computer-implemented system of claim 19, wherein the predetermined calculation method can select personal attribute variables or a processing method for transforming, converting, or weighting the value corresponding to the personal attribute variable.
